(19) United States
(12) Patent Application Publication
(10) Pub. No.: US 2025/0289163 A1
(43) Pub. Date: Sep. 18, 2025

(54) MONOLITHIC CONSTRUCTION 3D PRINTING PROCESS

(71) Applicant: SQ4D PATENT LLC, Patchogue, NY (US)

(72) Inventors: Kristen Elizabeth Henry, Patchogue, NY (US); Sal Ferrari, Shirley, NY (US)

(21) Appl. No.: 18/922,365

(22) Filed: Oct. 21, 2024

Related U.S. Application Data
(60) Provisional application No. 63/544,867, filed on Oct. 19, 2023.

(51) Int. Cl. B28B 1/00; B28B 23/02; B33Y 10/00; B33Y 30/00; B33Y 40/00

(52) U.S. Cl. CPC B28B 1/001; B28B 23/02; B33Y 10/00; B33Y 30/00; B33Y 40/00

(57) ABSTRACT

A construction 3D printing system is provided. The construction 3D printing system includes at least one frame having tracks and an x-axis carriage having a front plate, a volumetric mixer fluidly connectable to a source of powder material and a source of water, the volumetric mixer configured to combine the powder material and water to produce a building material, a pump configured to pump the building material through a material hose, and at least two subsystems. The subsystems may be extruder subsystems, rebar subsystems, insulation subsystems, or plastic 3D printing subsystems. Methods of constructing a 3D printed structure are also provided.

### CROSS-REFERENCE TO RELATED APPLICATIONS

This application claims priority under 35 U.S.C. § 119(e) to U.S. Provisional Patent Application No. 63/544,867 titled “Monolithic 3D Printed House” filed Oct. 19, 2023, the entire disclosure of which is herein incorporated by reference in its entirety for all purposes.

### TECHNICAL FIELD

The disclosure relates to systems and methods for constructing a monolithic 3D printed structure (e.g., a house). In particular, the disclosure relates to methods that include using a continuous batching process to allow for adjustment and control of the building material formula throughout the construction process. The disclosure also relates to a construction 3D printing system that includes different subsystems for constructing the various components of the monolithic 3D printed structure.

### SUMMARY

In accordance with one aspect, there is provided a construction 3D printing system. The system may comprise at least one frame comprising tracks and an x-axis carriage having a front plate. The system may comprise a volumetric mixer fluidly connectable to a source of powder material and a source of water, the volumetric mixer configured to combine the powder material and water to produce a building material. The system may comprise a pump configured to pump the building material through a material hose. The system may comprise at least two subsystems, each subsystem comprising a mounting plate connectable to the base plate of the x-axis carriage, the at least two subsystems selected from: a first extruder subsystem comprising a material pipe fluidly connectable to the material hose and an extruder having a puck positioned on a distal end; a second extruder subsystem comprising a material pipe fluidly connectable to the material hose and a tangentially rotating nozzle, the tangentially rotating nozzle having a non-circular opening; a rebar subsystem comprising a rebar dispenser; an insulation subsystem comprising an insulation dispenser fluidly connectable to a source of insulation material; and a plastic 3D printing subsystem comprising an extruder fluidly connectable to a source of plastic building material.

In some embodiments, the material pipe of at least one of the first extruder subsystem and the second extruder subsystem is dimensioned to deposit the building material at a subterranean depth.

In some embodiments, the first extruder subsystem or the second extruder subsystem further comprises a support truss supporting at least a portion of the material pipe.

In some embodiments, the system further comprises at least one hoist positioned on the tracks.

In some embodiments, the system further comprises at least one camera and/or at least one light positioned on the tracks or on the x-axis carriage.

In some embodiments, the source of plastic building material is a source of recycled plastic.

In some embodiments, the system further comprises at least one sensor selected from a heat or light sensor, a temperature sensor, a moisture sensor, a water level sensor, a powder material level sensor, and a sand or admixture level sensor, the at least one sensor configured to measure a property of the building material or the environment.

In some embodiments, the at least one sensor is operably connectable to a control box programmed to adjust a build protocol responsive to a measurement received from the at least one sensor.

In some embodiments, the system further comprises at least one paint sprayer fluidly connectable to a source of paint, the at least one paint sprayer positionable on the tracks or x-axis carriage.

In some embodiments, the system further comprises at least one mister fluidly connectable to a source of water, the at least one mister positionable on the tracks or x-axis carriage.

In some embodiments, the system further comprises slicing blades configured to reciprocate or vibrate.

In some embodiments, the volumetric mixer is further fluidly connectable to at least one source of an admixture.

In accordance with another aspect, there is provided a construction 3D printing subsystem comprising at least one frame comprising tracks and an x-axis carriage; a volumetric mixer fluidly connectable to a source of powder material and a source of water, the volumetric mixer configured to combine the powder material and water to produce a building material; a pump configured to pump the building material through a material hose to an extruder, the extruder dimensioned to deposit the building material at a subterranean depth; and at least one of a removable non-circular nozzle and a removable puck positionable at a distal end of the extruder.

In some embodiments, the system further comprises a support truss supporting at least a portion of the extruder.

In accordance with another aspect, there is provided a construction 3D printing system comprising at least one frame comprising tracks and an x-axis carriage; a volumetric mixer fluidly connectable to a source of powder material and a source of water, the volumetric mixer configured to combine the powder material and water to produce a building material; a pump configured to pump the building material through a material hose to an extruder; and a rebar dispenser connected to a rebar hopper comprising a plurality of rebar sticks.

In accordance with another aspect, there is provided a construction 3D printing system comprising at least one frame comprising tracks and an x-axis carriage; a volumetric mixer fluidly connectable to a source of powder material and a source of water, the volumetric mixer configured to combine the powder material and water to produce a building material; a pump configured to pump the building material through a material hose to an extruder; and a control box operably connected to the volumetric mixer, the control box programmed to instruct the volumetric mixer to combine the powder material and water to produce the building material having a target viscosity in accordance with a build protocol.

In accordance with another aspect, there is provided a construction 3D printing system comprising at least one frame comprising tracks and an x-axis carriage; a volumetric mixer fluidly connectable to a source of powder material and a source of water, the volumetric mixer configured to combine the powder material and water to produce a building material; a pump configured to pump the building material through a material hose to an extruder; and an insulation dispenser comprising an insulation hose fluidly connectable to a source of insulation material.

In accordance with another aspect, there is provided a method of building a subterranean structure with a construction 3D printing system comprising at least one frame comprising tracks and an x-axis carriage, a source of a building material, and a pump configured to pump the building material through a material hose. The method may comprise attaching an extruder dimensioned to reach subterranean depths to the x-axis carriage, fluidly connecting the extruder to the material hose, and printing a subterranean footing in a trench. The method may comprise depositing rebar at least partly into the footing. The method may comprise attaching a tangentially rotating non-circular nozzle to the x-axis carriage, fluidly connecting the tangentially rotating non-circular nozzle to the material hose, and printing foundation walls over the subterranean footing. The method may comprise installing insulation adjacent the foundation walls. The method may comprise printing slab above the foundation walls.

In some embodiments, printing the subterranean footing comprises printing a barrier wall around a perimeter of the subterranean footing with a first building material having a higher viscosity and backfilling the subterranean footing with a second building material having a lower viscosity.

In some embodiments, the method further comprises attaching a rebar dispenser to the x-axis carriage to deposit the rebar.

In some embodiments, the method further comprises attaching a puck to the extruder to smooth at least one of the subterranean footing and the slab.

In some embodiments, the method further comprises painting a mock wall onto the slab to identify locations for stub-ups.

In some embodiments, the method further comprises performing periodic cleanouts of the material hose.

In some embodiments, the method further comprises digging the trench with a digging apparatus attached to the x-axis carriage.

In accordance with another aspect, there is provided a method of building a roof on a structure with a construction 3D printing system comprising at least one frame comprising tracks and an x-axis carriage, a source of a building material, and a pump configured to pump the building material through a material hose to an extruder. The method may comprise printing walls of the structure with a nozzle fitted to the extruder. The method may comprise depositing insulation adjacent the walls. The method may comprise embedding a plurality of j-hooks into bond beam installed around a perimeter of the structure. The method may comprise lifting at least one decking panel onto the walls and attaching the decking panel to the j-hooks. The method may comprise printing the roof over the decking.

In some embodiments, printing the roof comprises printing a barrier wall around a perimeter of the roof with a first building material having a higher viscosity and backfilling the roof with a second building material having a lower viscosity.

In some embodiments, the method further comprises attaching a puck to the extruder of the construction 3D printing system to smooth the roof.

In some embodiments, the method further comprises attaching an insulation dispenser to the x-axis carriage to deposit the insulation.

In some embodiments, the method further comprises performing periodic cleanouts of the material hose.

In some embodiments, the method further comprises misting the walls, painting the walls, or producing a fixture of the structure during a periodic cleanout.

In some embodiments, the decking panel is lifted by attaching the decking panel to at least one hoist positioned on the tracks or the x-axis carriage.

In accordance with another aspect, there is provided a method of building a 3D printed structure with a construction 3D printing system comprising at least one frame comprising tracks and an x-axis carriage, a volumetric mixer fluidly connected to a source of a powder material and a source of water, the volumetric mixer configured to produce a building material, and a pump configured to pump the building material through a material hose to an extruder. The method may comprise printing a plurality of components of the structure, including two or more of: printing a subterranean footing in a trench, printing foundation walls above the subterranean footing, printing a slab above the foundation walls, printing walls of the structure above the slab, and printing a roof above decking panels positioned above the walls. The method may comprise controlling a combination of the powder material and the water in the volumetric mixer to produce the building material having a target viscosity selected for each component of the structure.

In some embodiments, printing the subterranean footing comprises printing a barrier wall around a perimeter of the subterranean footing with the building material having a first viscosity and backfilling the subterranean footing with the building material having a second viscosity lower than the first viscosity.

In some embodiments, printing the roof comprises printing a barrier wall around a perimeter of the roof with the building material having a first viscosity and backfilling the roof with the building material having a second viscosity lower than the first viscosity.

In some embodiments, the volumetric mixer is further fluidly connected to a source of an admixture, the method comprising controlling combination of the powder material, the water, and the admixture to produce the building material having a target composition selected for each component of the structure.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is an isometric view of the construction 3D printer, according to certain embodiments;

FIG. 1B is a partial front view of the construction 3D printer, according to certain embodiments;

FIG. 1C is a partial side view of the construction 3D printer, according to certain embodiments;

FIG. 2 is an isometric view of the X-carriage, according to certain embodiments;

FIG. 3 is an isometric view of the extruder for footing printing, according to certain embodiments;

FIG. 4 is an isometric view of the extruder for foundation wall printing, according to certain embodiments;

FIG. 5 is an isometric view of the extruder for slab printing, according to certain embodiments;

FIG. 6A is an isometric view of the tangentially rotating extruder with an auger, according to certain embodiments;

FIG. 6B is an isometric view of a tangentially rotating extruder, according to certain embodiments;

FIG. 6C is a cross-sectional view of the tangentially rotating extruder with an auger, according to certain embodiments;

FIG. 6D is an isometric view of a rectangular nozzle, according to certain embodiments;

FIG. 6E is an isometric view of an oval nozzle, according to certain embodiments;

FIG. 7A is an isometric view of a gluing system, according to certain embodiments;

FIG. 7B is a close-up view of the gluing system in action, according to certain embodiments;

FIG. 8A is an isometric view of the slicing apparatus, according to certain embodiments;

FIG. 8B is a close-up view of the slicing apparatus in action, according to certain embodiments;

FIG. 9A is an isometric view of the insulation subsystem, according to certain embodiments;

FIG. 9B is a close-up view of the insulation subsystem in action, according to certain embodiments;

FIG. 10A is a bottom isometric view of the rebar subsystem, according to certain embodiments;

FIG. 10B is a side cross sectional view of the rebar subsystem, according to certain embodiments;

FIG. 10C is a close-up view of the rebar dropping system in action, according to certain embodiments;

FIG. 11A is a view of the camera system on the X-axis carriage, according to certain embodiments;

FIG. 11B is an isometric view of the camera and lights on the tower, according to certain embodiments;

FIG. 11C is a flow chart of the LIDAR sensing for bead width adjustment, according to certain embodiments;

FIG. 11D is a diagram of the LIDAR sensor for bead with adjustment, according to certain embodiments;

FIG. 12A is an isometric view of misting system clips, according to certain embodiments;

FIG. 12B is a front view of the misting system controls, according to certain embodiments;

FIG. 12C is an isometric view of the misting ring on the X-carriage, according to certain embodiments;

FIG. 12D is a flow chart of misting subsystem automation, according to certain embodiments;

FIG. 12E is a continuation flow chart from FIG. 12D of the misting subsystem automation, according to certain embodiments,

FIG. 12F is a view of the misting subsystem in action, according to certain embodiments;

FIG. 13A is a close-up view of the paint sprayer apparatus on the Z-tower, according to certain embodiments;

FIG. 13B is a close-up view of the paint sprayer apparatus on the X-carriage, according to certain embodiments;

FIG. 14A is an isometric view of a rolling attachment, according to certain embodiments;

FIG. 14B is an isometric view of a rolling attachment, according to certain embodiments;

FIG. 14C is an isometric view of a rolling attachment, according to certain embodiments;

FIG. 14D is a close-up view of a rolling attachment in action, according to certain embodiments;

FIG. 15A is an isometric view of the mark-out apparatus, according to certain embodiments;

FIG. 15B is a zoomed-out view of the mark-out apparatus in action, according to certain embodiments;

FIG. 15C is a close-up view of the mark-out apparatus in action, according to certain embodiments;

FIG. 16A is an isometric view of the digging apparatus, according to certain embodiments;

FIG. 16B is an isometric view of the hydro-vacuum apparatus, according to certain embodiments;

FIG. 17 is an isometric view of the extruder extension for basement printing, according to certain embodiments;

FIG. 18A is a zoomed-out view of the subterranean footings being printed, according to certain embodiments;

FIG. 18B is a close-up view of the subterranean footings being printed, according to certain embodiments;

FIG. 19A is a zoomed-out view of the foundation wall being printed, according to certain embodiments;

FIG. 19B is a close-up view of the foundation wall being printed, according to certain embodiments;

FIG. 19C is a close-up view of the key printed in the backfilled foundation wall, according to certain embodiments;

FIG. 20A is a zoomed-out view of the conduit installation in the slab, according to certain embodiments;

FIG. 20B is a zoomed out view of the slab, according to certain embodiments;

FIG. 20C is zoomed-out view of the slab being printed, according to certain embodiments;

FIG. 21A is a close-up view of the rebar hook connection points in the foundation, according to certain embodiments;

FIG. 21B is a close-up view of the lattice reinforcing mesh in the printed wall, according to certain embodiments;

FIG. 21C is a close-up view of the printing reinforcing wire in the bead, according to certain embodiments;

FIG. 22A is a zoomed-out view of the interior and exterior walls being printed, according to certain embodiments;

FIG. 22B is a close-up view of the interior and exterior walls being printed, according to certain embodiments;

FIG. 23A is a diagram of wall features, according to certain embodiments;

FIG. 23B is a diagram of wall terminology, according to certain embodiments;

FIG. 23C is a diagram of a technique used to produce nearly 90 degree corners, according to certain embodiments;

FIG. 24A is a close-up view of the lifting apparatus on the printer, according to certain embodiments;

FIG. 24B is a close-up view of the framed rough opening, according to certain embodiments;

FIG. 25 is a close-up view of the cleanout process, according to certain embodiments;

FIG. 26 is a close-up view of the structural support column backfilling process, according to certain embodiments;

FIG. 27A is a zoomed-out view of the bond beam being printed, according to certain embodiments;

FIG. 27B is a close-up view of the J-bolts installed in the bond beam, according to certain embodiments;

FIG. 28A is a zoomed-out view of wooden roof truss installation, according to certain embodiments;

FIG. 28B is a close-up view of the lifting mechanism placing wooden trusses, according to certain embodiments;

FIG. 28C is a zoomed-out view of steel decking installation, according to certain embodiments;

FIG. 28D is a close-up view of steel decking being placed, according to certain embodiments;

FIG. 28E is a close-up view of roof printing, according to certain embodiments;

FIG. 29A is a zoomed-out view an additional feature such as a pool being printed, according to certain embodiments;

FIG. 29B is a zoomed-out view of an additional feature such as a staircase being printed, according to certain embodiments;

FIG. 30A is an isometric view of a plastic 3D printing system, according to certain embodiments;

FIG. 30B is a close-up view of the installation of a plastic 3D printed item (trim), according to certain embodiments;

FIG. 31 is an isometric view of the robotic arm attachment on the 3D printer, according to certain embodiments;

FIG. 31A is a close-up view of the robotic arm attachment in use, according to certain embodiments;

FIG. 32A is an isometric view of the towing attachment on the 3D printer, according to certain embodiments;

FIG. 32B is a close detailed isometric view illustrating the wheels of the towing attachment of FIG. 32A, according to certain embodiments;

FIG. 33 is a diagram of the site layout, according to certain embodiments;

FIG. 34A is a flowchart of the temperature sensor feedback in the volumetric mixer, according to certain embodiments;

FIG. 34B is a flowchart of the moisture sensor feedback in the volumetric mixer, according to certain embodiments;

FIG. 34C is a flowchart of the water level sensor feedback in the volumetric mixer, according to certain embodiments;

FIG. 34D is a flowchart of the powdered material level sensor feedback in the volumetric mixer, according to certain embodiments;

FIG. 34E is a flowchart of the sand sensor feedback in the volumetric mixer, according to certain embodiments;

FIG. 35A is a flowchart of the overall steps, according to certain embodiments;

FIG. 35B is a continuation of the flowchart of FIG. 35A, according to certain embodiments; and

FIG. 36 is a box diagram of the volumetric mixer and sensors, according to certain embodiments.

### DETAILED DESCRIPTION

Conventional construction 3D printing systems that are used to create different components of a monolithic structure have been established in literature. However, these conventional construction 3D printing systems currently only have the ability to print discrete elements of structures. Additionally, the conventional printing process has many interruptions between steps, which leaves the structures susceptible to weak points.

The methods disclosed herein may be used to 3D print an entire structure with unprecedented strength, speed, safety, and cost savings, as compared to conventional construction 3D printing methods. In certain embodiments, the methods disclosed herein may be used to 3D print an entire structure in an uninterrupted, continuous process.

As compared to traditional structure construction methods, such as stick-built or concrete block construction methods, 3D printing structures can reap tremendous cost and time savings. Although the field of construction 3D printing has advanced rapidly, the current 3D printing technologies lack the ability to create continuous, monolithic structures. Rather than printing a house or other structure in a single procedure, conventional systems print individual components such as the foundation, slab, interior and exterior walls, and roof, using different methods with substantial wait times in between that lead to cold joints and weak points in the structure.

Provided is a method for manufacturing a continuous 3D printed structure on site. In some embodiments, the method includes manufacturing one or more of the subterranean footings, foundation walls, basement, slabs, interior, exterior walls, additional structures, and the roof in an uninterrupted process. With the disclosed methods, it is believed that there is no longer a need for traditional concrete forms (temporary molds or barriers that are later removed) and their corresponding wait times, and the resulting structure is stronger and water impervious by nature of being built without interruptions in the process. The resulting structure is less expensive and more efficient to produce, due to the shorter carrying costs and the reduction in different trades and workers involved.

In addition to a continuous outer structure, the methods disclosed herein may allow an unprecedented amount of the home to be 3D printed, including, for example, interior and exterior fixtures and accessories. For instance, in certain embodiments, a recycling plastic printer may be used to print interior components of the home such as trim, molding, cabinets, doors, and other features. This may be possible due to the integration of various technological systems with an Autonomous Robotic Construction System, for example, as disclosed in U.S. Patent Application Publication No. 2019/0316344, titled “Autonomous robotic construction system and method,” which is herein incorporated by reference in its entirety for all purposes.

The disclosure provides a technology for manufacturing a complete and monolithic 3D printed structure, also known as a builder's shell & core, with a significant reduction in building materials as compared to traditional construction practices. For example, stick-built construction generally requires sheetrock, siding, sheathing, framing, nails, house wrap (e.g., Tyvek®, distributed by DuPont™, Wilmington, DE), staples, fire stops, and more. The methods disclosed herein may eliminate the need for many of those materials, and produce less or essentially no waste (as typically such materials need to be cut to size, with the remaining material being discarded).

Gaps between components in stick built structures are common due to the use of many different materials, installation techniques, and ineffective fastening methods. Gaps between components in conventional construction 3D printed structures are also common due to delamination and formation of cold joints between the different 3D printed components. The methods disclosed herein may also reduce or eliminate mold that often grows between layers of these components and materials.

In certain embodiments, the continuous process disclosed herein may include an on-the-spot batching method for building material creation. In some embodiments, a waterproofing admixture may be added to the building material, allowing for an impervious shell, such that no demolition would be required in the case of flooding. In some embodiments, structural fibers or other admixtures and additives may be added to the building material in order to enhance strength or provide other properties. Certain methods may include sequestering carbon dioxide in the mixture, using recycled glass in place of sand, entrapping air, using colorant, and/or adding coal fly ash to the material. In certain embodiments, continuous building method of the structure includes processes such as misting the concrete to provide hydration, which may be used to advance the curing process and increase strength of the concrete.

In some embodiments, the system disclosed herein may be working continuously. Continuous functions may also include use of the pump, for example, during a cleanout. It is believed that the use of the on-the-spot batching method, the modular characteristics of the machine, and the integration of other processes normally done by general contractors or other specialists, may enable complete and monolithic 3D printing of a structure.

As disclosed herein, there is a provided method for manufacturing a monolithic structure using 3D printing. The structure 3D printed by the methods disclosed herein may include one or more of the footings, foundation walls, basement, slab, interior and exterior walls, and roof. Structures built as continuous units by the methods disclosed herein may generally mitigate the common problems in both conventional and current 3D printed construction such as air leakage, moisture infiltration, thermal bridging, pest infestation, sound transmission, and structural weaknesses. The structure produced by the methods disclosed herein may be more energy efficient due to a higher R value, and may receive a higher Home Energy Rating System (HERS) rating. In some embodiments, the systems and methods disclosed herein may be used to build structures capable of being classified as a Class 1 Fireproof Structure, or a Class 2 Fire Protected structure, for example, by using a building material that is non-flammable, optionally throughout the construction.

Additionally, by using the methods disclosed herein, it is believed that supply chain issues may be reduced or eliminated, as the materials used to build the 3D printed structure may be locally sourced. Using readily available, local materials also allows all parts of the structure to be built using the same material base and the same or similar material composition. This in turn allows for consistent expansion and contraction of the structure, which may further reduce or eliminate the incidence of crack formation in the structure.

Even in comparable construction methods, variation in the materials causes different contraction and expansion between elements. In block and mortar methods, the different formulas and ingredients between the blocks and the mortar may cause inconsistencies in the integrity of the structure over time. This problem may also occur with conventional construction 3D printing methods that rely on outside sources for material. When premixed material is delivered to the system from an external source, e.g., is delivered to the site in one or more trucks, the composition may not be consistent. In accordance with certain embodiments, the methods disclosed herein utilize the same source local batching of materials. Thus, the material for the entire construction may be consistent, and expand and contract consistently.

### Description of Construction 3D Printing System

In accordance with certain embodiments, an exemplary construction 3D printer system may include several subsystems and attachments. Use of the one or more subsystems and attachments may make the continuous building process possible.

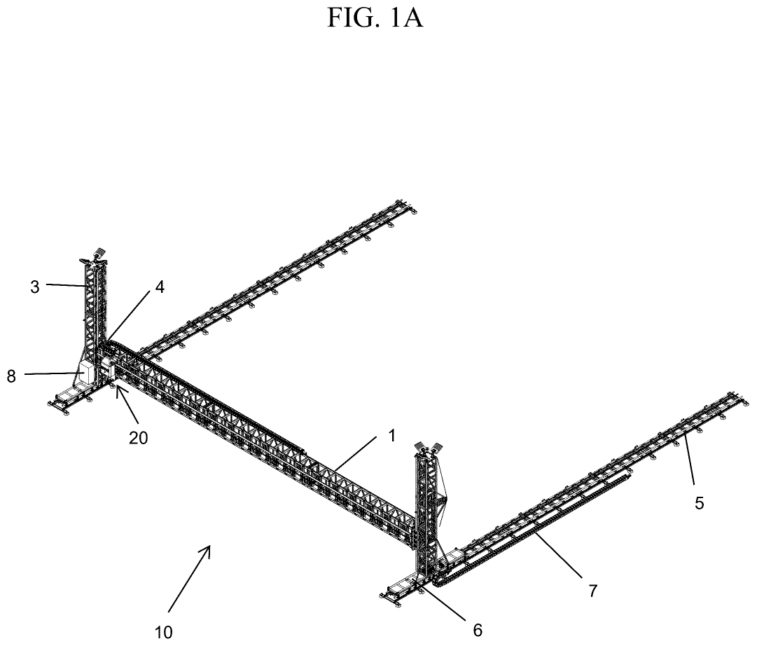

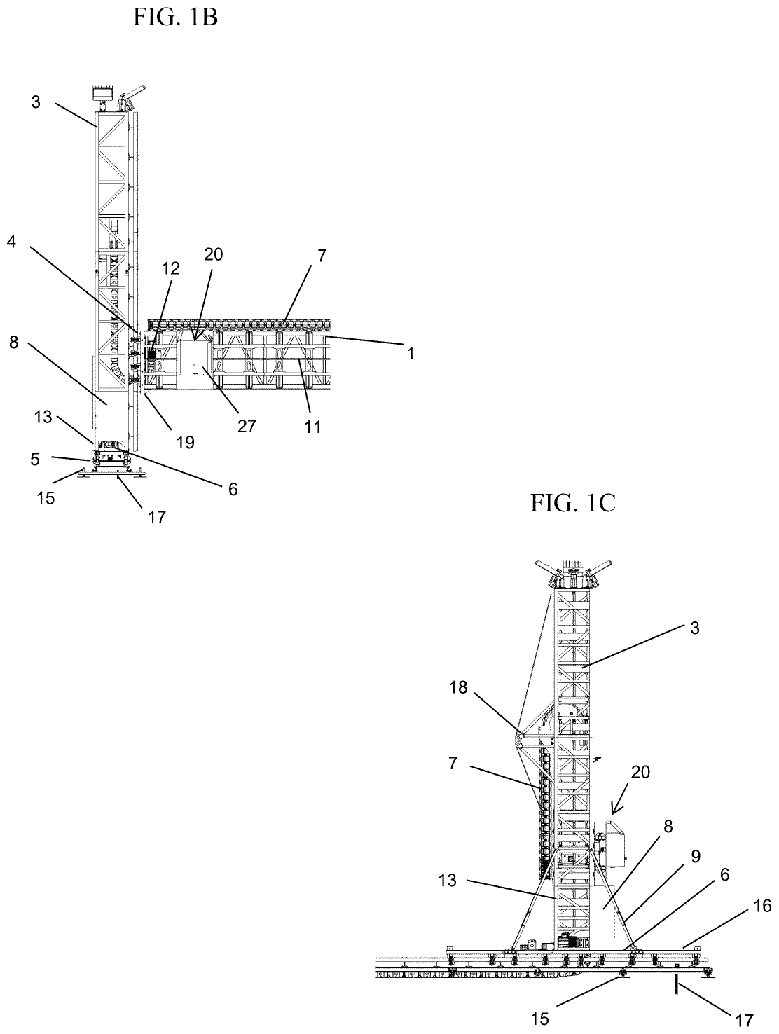

As seen in FIG. 1A, the exemplary construction 3D printer 10 contains an x-axis gantry 1 extending between y-axis tracks 5 that are positioned substantially parallel, and z-axis towers 3 extending from the y-axis tracks 5 to allow for multi directional movement and the creation of layered 3-dimensional structures. The y-axis tracks 5 may allow for back and forth movement of the x-axis gantry 1. The z-axis towers 3 may allow for up and down movement of the x-axis gantry 1.

Each axis may use a carriage and motion system. Each axis may be assembled to have a desired length by placement of additional pieces to allow for a desired overall print area. For instance, each of x-axis gantry 1, y-axis tracks 5, and z-axis towers 3 may be made extendable by incorporating additional rail segments (such as z-axis tower segments 13) of variable lengths, placed either below or above a main segment. Y-axis tracks 5 may be adjustable by leveling feet 15 and held down to the ground with earth anchors 17. Leveling feet 15 may allow the machine base to be leveled, which in turn may allow for more stable and level printing, despite variations on the surface of the ground.

As seen in FIG. 1B, a front view of FIG. 1A, the x-axis carriage 20 may be mounted to the x-axis gantry 1 in a variety of ways, and may be various shapes or sizes. For example, in some embodiments, the x-axis carriage 20 may be front mounted, top mounted, undermounted, or wrapped around (e.g., on 2 to 4 sides) the x-axis gantry 1. The x-axis gantry 1 may be mounted to the z-axis carriages 4 in a variety of orientations. For example, the x-axis gantry 1 may be mounted to the z-axis carriages 4 on the front, side, top, or bottom, and may be various shapes or sizes. A mountable extruder subsystem may optionally comprise an extruder plate cover 27.

In some embodiments, the x-axis carriage 20 may be positioned to move along the x-axis gantry 1 using a motion system 11. Exemplary motion system 11 is a rack and pinion drive system. However, other motion systems, such as a belt driven system, may be used to achieve linear motion along the x-axis gantry 1. The X-axis gantry 1 may be mechanically coupled to z-axis carriage 4, which is mechanically coupled to the vertical z-towers 3 by wheel assemblies and z-motion system 12. Other mechanical coupling assemblies may be used. Using the z-motion system, the z-carriage 4 may travel up and down in the vertical direction along the z-tower 3 to move the x-axis gantry 1 up and down in the vertical direction. The Z-axis tower 3 may fold by tower folding mechanism 18, which includes a pulley and winch, or may bolt together as separate trusses.

As seen in FIG. 1C, y-axis carriage 6 may also be made extendable by incorporation of additional carriages 16 in order to increase footprint and stability. Bracing supports 9 may be used at variable heights and angles to reinforce and stabilize z-towers 3.

The x-axis carriage 20 may travel along the stable structure of the x-axis gantry 1. Z-axis carriage 4 may travel up and down the z-axis towers 3 in order to move the x-axis gantry 1 up and down in the vertical direction. In certain embodiments, the z-axis carriage 4 may include a support surface or shelf 19 for attachment of the x-axis gantry 1 thereto. Y-axis carriages 6 may travel back and forth on y-axis tracks 5 with y-axis motion system 14, in order to move the x-axis gantry 1 and z-axis towers 3 along the length of the print.

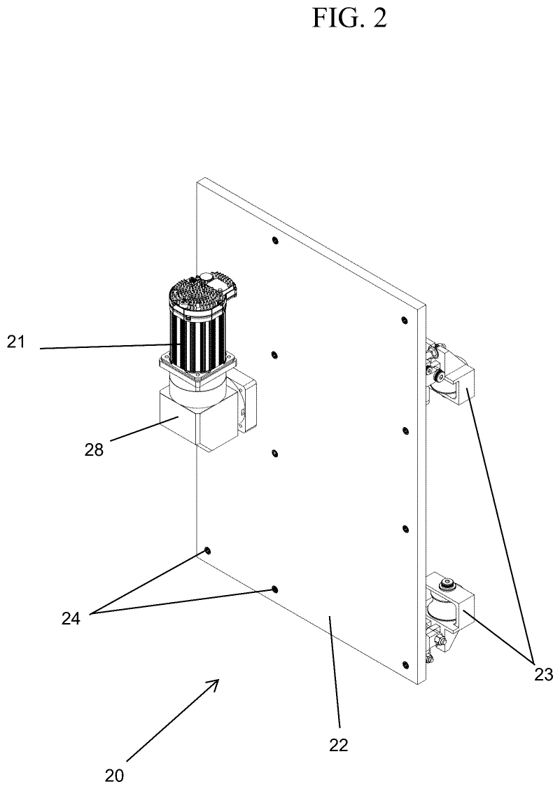

As shown in FIG. 2, x-axis carriage 20 may be moved horizontally by motor 21 with motor torque and speed ratios optionally altered with gearbox 28. Wheel assemblies 23 may be positioned on each end of x-axis carriage 20 to allow for movement along the rails of the x-axis gantry 1. X-axis carriage 20 may include its own control box 25, which may optionally be operably connected to control box 8. X-axis carriage 20 may include a base plate 22 that accommodates one or multiple different printing and utility subsystems. Base plate 22 may include universal receivers that accommodate corresponding fasteners. Exemplary universal receivers include bolt holes 24 shown in FIG. 2.

Exemplary subsystems that may be fastened to x-axis carriage 20 include, but are not limited to, extrusion subsystems include an extruder for subterranean printing 30, an extruder for foundation wall printing 40, an extruder for slab printing 50, a tangentially rotating extruder 60, an extruder for basement printing 170, a rebar subsystem 100, and insulation subsystem 90. Exemplary attachments that may be fastened to x-axis carriage 20 or a rail, such as x-axis gantry 1, z-axis towers 3, or y-axis tracks 5 include, but are not limited to, cameras 111 and lights for print quality observation, sensors, e.g., environmental sensors or sensors for measurement of bead thickness, misting nozzles 121, paint spray heads 131, hoists, wall slicers, etc.

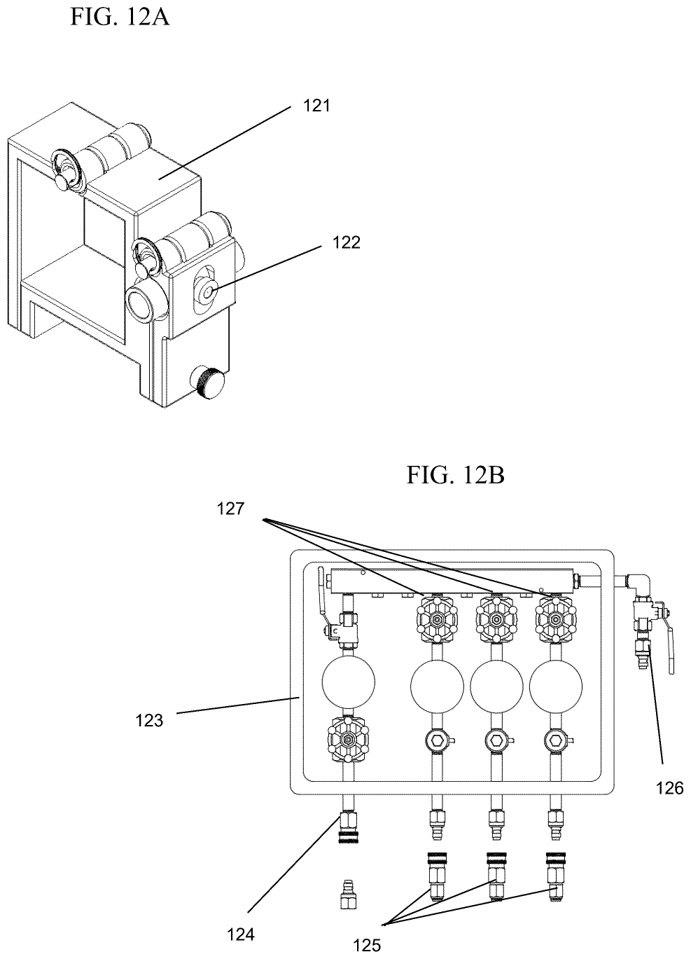

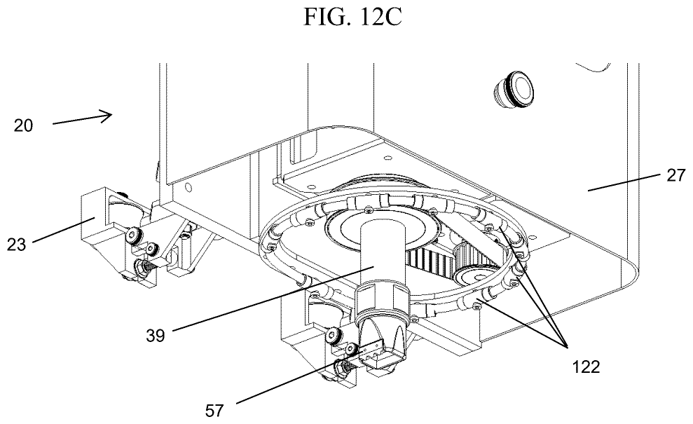

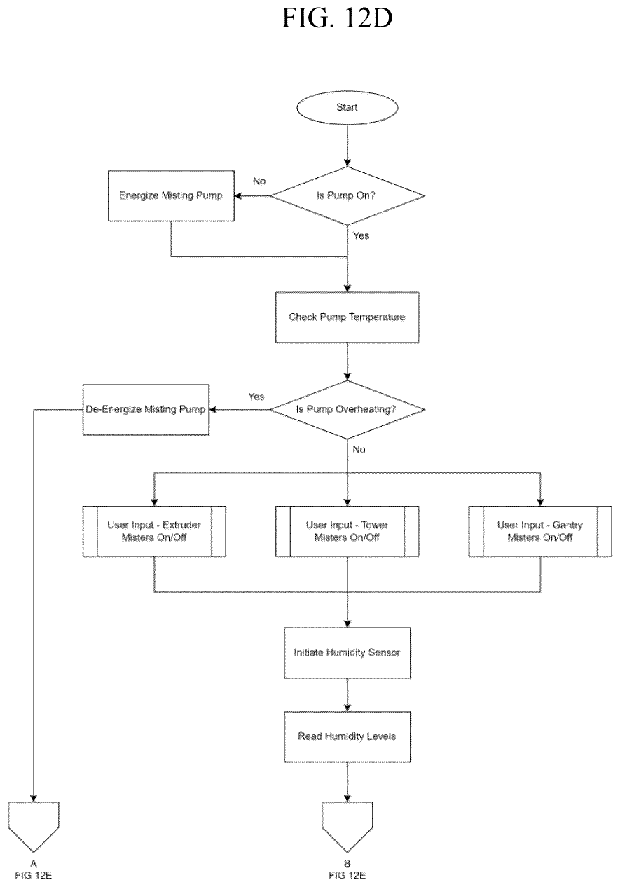

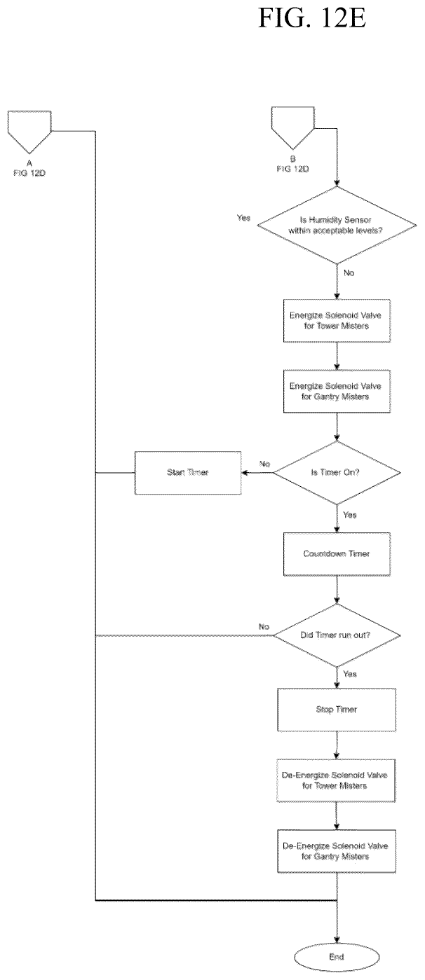

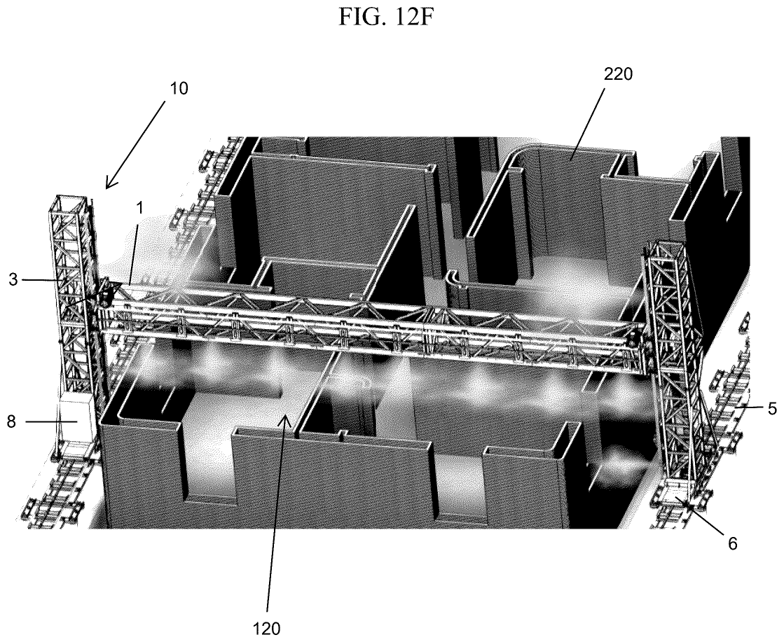

In some embodiments, the x-axis gantry 1 may contain misting nozzle clips 121 having a misting nozzle 122 (FIGS. 12A-12B), which may be used to spray water delivered by a pump through manifold control 123 to the deposited material in various zones 125, to control hydration of the deposited building material. In use, misting water may enter the water inlet 124 from a pump or power washer. The manifold 123 may include a power washer pass through 126. Valves 127 may be provided to control pressure of the misting water. The valves may be manually actuated or automatically actuated. The misting manifold control 123 may be expandable to multiple different zones 125, depending on the print areas requiring misting. In certain embodiments, the misting nozzles 122 may be organized as a misting ring (FIG. 12C) positioned adjacent to the nozzle 57.

FIGS. 12D-12E are an exemplary control scheme for use of the misting clips 121. As shown in FIGS. 12D-12E, the misting clips 121 may be energized by solenoid valves. A timer may be used to control operation of the misting nozzles 122. In certain embodiments, the misting operation may be performed responsive to a reading obtained by a humidity sensor. In some embodiments, the humidity sensor may be operably connected to control box 8. Control box 8 may be programmed to actuate the misting nozzles 122 responsive to a measurement obtained from the humidity sensor.

In certain embodiments, tubing may be routed through a tubing management channels 7 on one or more rail, such as x-axis gantry 1, z-towers 3, or y-axis tracks 5. For instance, the hosing for material delivery, electronic cables, etc. may be routed through appropriate channels 7. Thus, in certain embodiments, the system may include tubing channels 7. Such channels 7 may be formed within or partially within the rails or be external to the rails (e.g., gantry or tower).

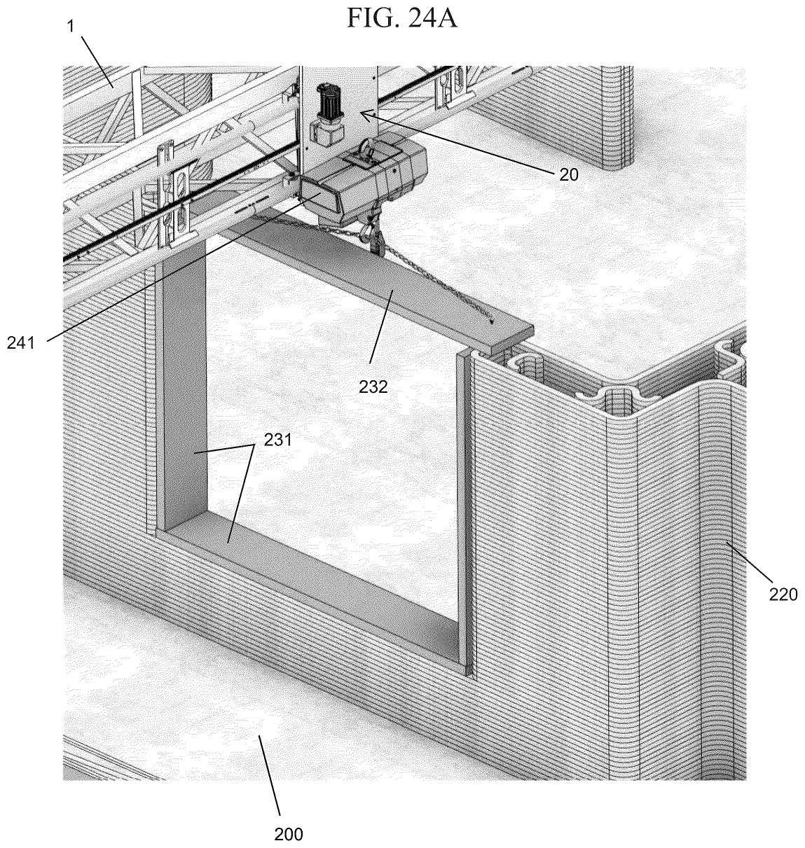

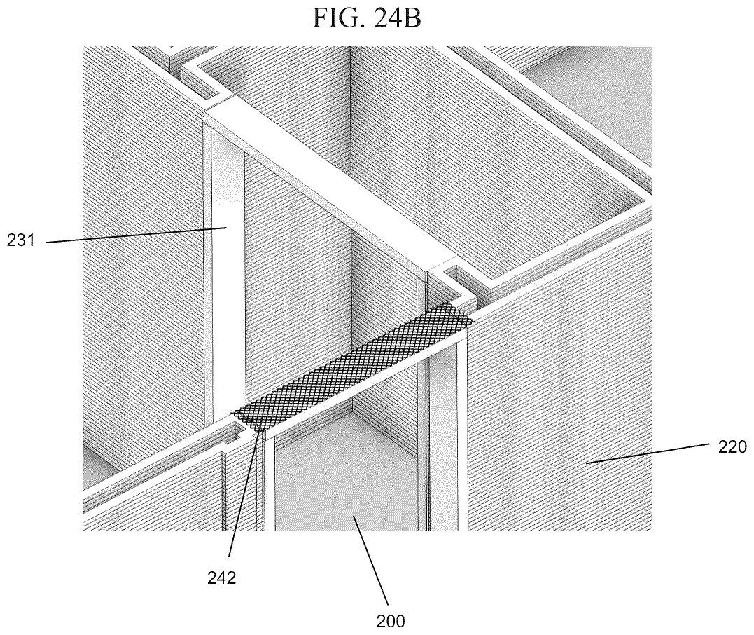

In certain embodiments, one or more rail, such as x-axis gantry 1, may also function as a lifting device, for example, as seen in the exemplary system of FIG. 24A. Using x-axis gantry 1 as a lifting device may eliminate the need for cranes and other large pieces of equipment or machinery on site. Thus, in certain embodiments, the gantry, e.g., x-axis gantry 1, may include one or more hoists 241 capable of lifting items or materials. In one exemplary embodiment, as shown in FIG. 24A, the hoist 241 may be attached to x-axis gantry 1, for example, x-axis carriage 20, and used to lift headers or lintels 232 when framing rough openings. In other embodiments, hoist 241 may be used to lift steel roofing panels when installing roof decking. Since the exemplary modular system may, in some embodiments, be set up without the use of heavy duty equipment, like cranes or telehandlers, system components may, in some embodiments, be used to perform the functions of some of these pieces of equipment. Thus, use of the systems disclosed herein may significantly reduce the number of machines on the construction site.

FIG. 24B further illustrates an exemplary installation process for framing material that may be used for rough openings. In certain embodiments, the framing materials include beams 231 which may be placed vertically or horizontally. In certain embodiments, the beams 231 may be formed of different materials, such as and not limited to, wood, plastic, metal (e.g., steel), or others. Mesh 242 may be laid on top of the lintel 232, to support adhesion of the next layer of printed walls 220. The system may include a control box 8. The control box 8 may be operably connected to one or more motors, such as motor 21, and programmed to control the movement of the x-axis carriage 20, z-axis carriage 4, and/or y-axis carriage 6 in accordance with print instructions. Control box 8 may contain the CPU and electronic components used to control the movement of the printer and the functions of the various technological systems and components in the exemplary system disclosed herein. Thus, the control box 8 may be operably connected to one or more pumps, sensors, subsystems, components, attachments, or motors disclosed herein, that drive operation of the system.

In some embodiments, the control box 8 may be operably connected to a user interface. The user interface may be a local or remote user interface. The user interface may be programmed to receive print instructions from a user and send the print instructions to the control box 8 to operate the system in accordance with the protocol. In some embodiments, the control box 8 may contain a memory storing device or be operably connected to a memory storage device. The memory storage device may store print instructions for one or more print protocols.

The construction 3D printer may be controlled with a remote control, tablet, computer, or other device that interfaces with the control software, e.g., via the user interface. Optionally, the construction 3D printer may be controlled from a remote location (i.e. by a remote operator). In the case of the local operator, a seat and manual controls may be located on the y-carriage, x-axis gantry or x-axis carriage, or elsewhere on the system.

Various subsystems may be attached to x-carriage 20. Thus, in some embodiments, the system may include one or more subsystems mountable to the x-axis carriage 20. Exemplary subsystems are described in more detail below. The various subsystems may be used to perform different functions and may include different extruders, nozzle heads, dispensers, or other components configured to perform a selected function.

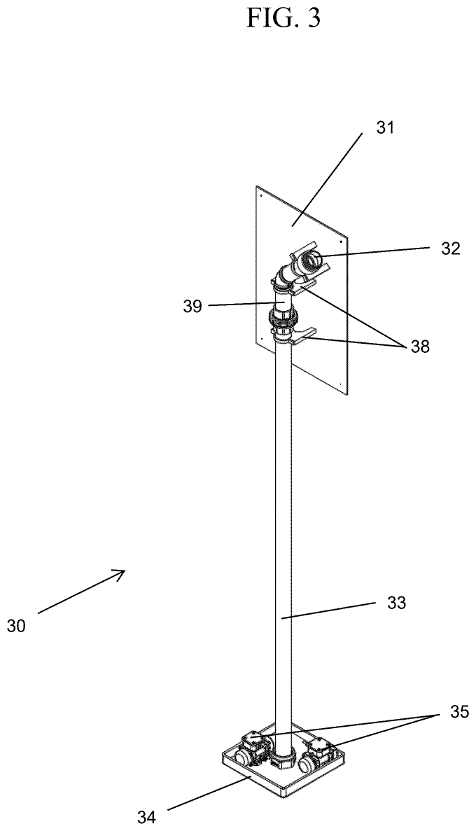

As shown in the exemplary subsystems of FIGS. 3-5, in some embodiments, each subsystem may include a mounting plate 31. The mounting plate 31 may be configured for attachment to the base plate 22 of the x-axis carriage 20. In some embodiments, the mounting plate 31 may include a fastener, such as a bolt or other fastener that is attachable to the receiver 24 of the base plate 12. In other embodiments, the subsystems do not include a mounting plate 31. Thus, in some embodiments, the subsystems may be mountable to the x-axis carriage 20 by any fastening structure available. Mounting brackets 38 may hold the extruder subsystem to mounting plate 31 or directly onto x-axis carriage 20.

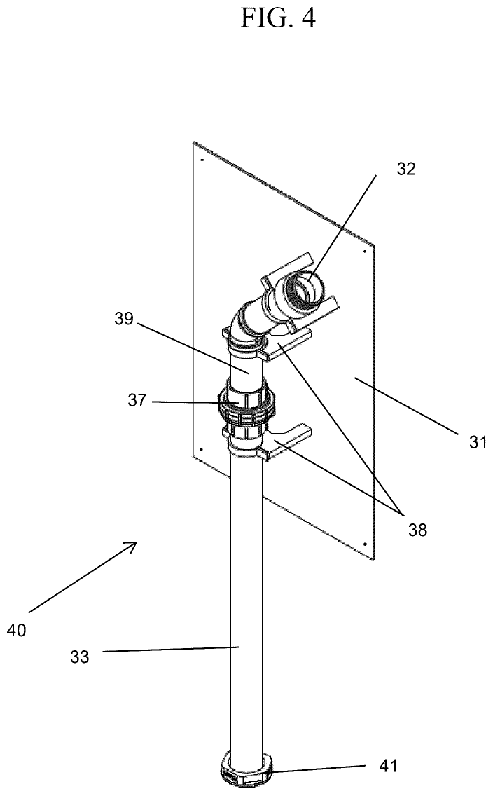

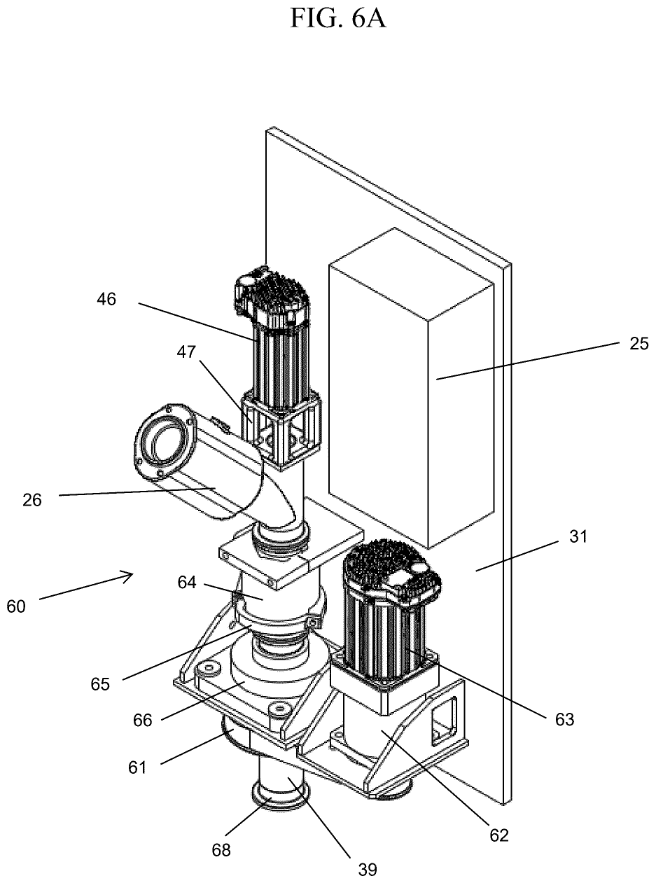

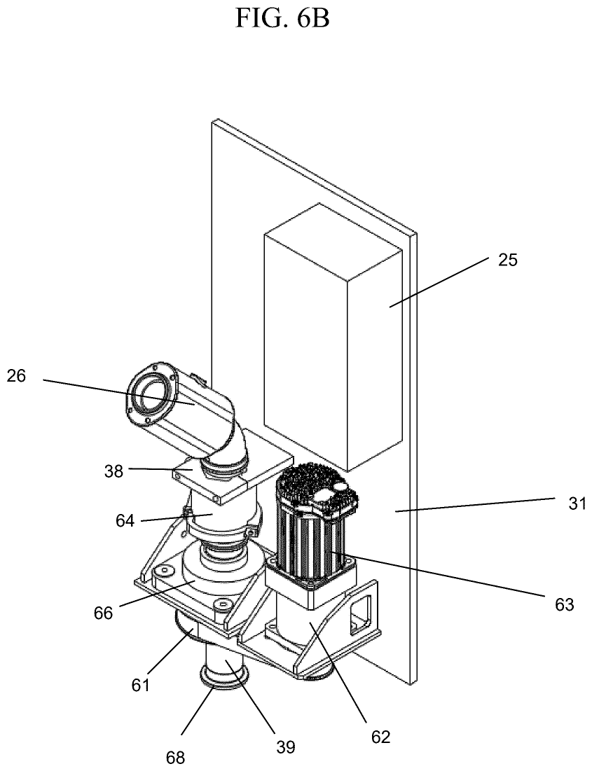

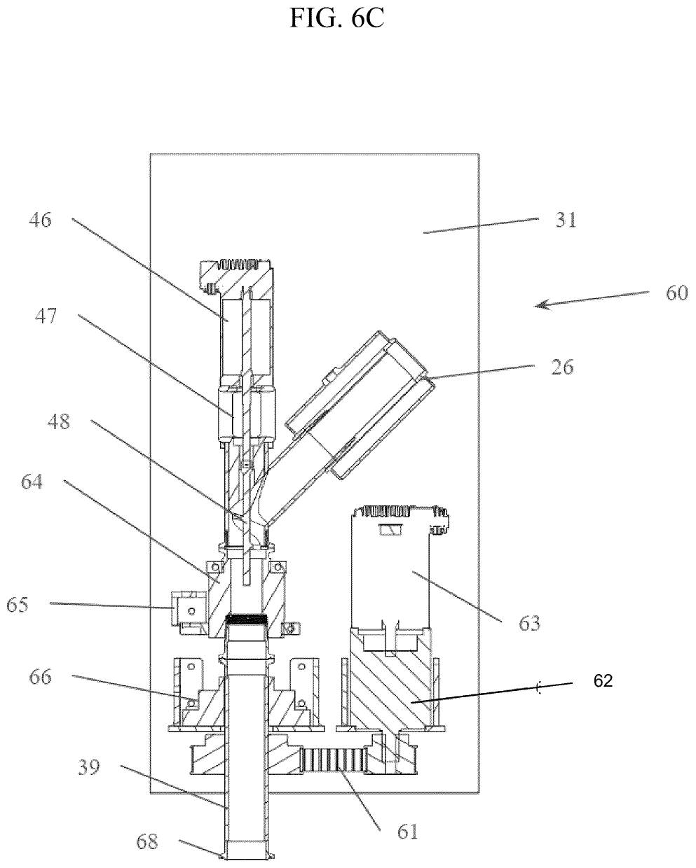

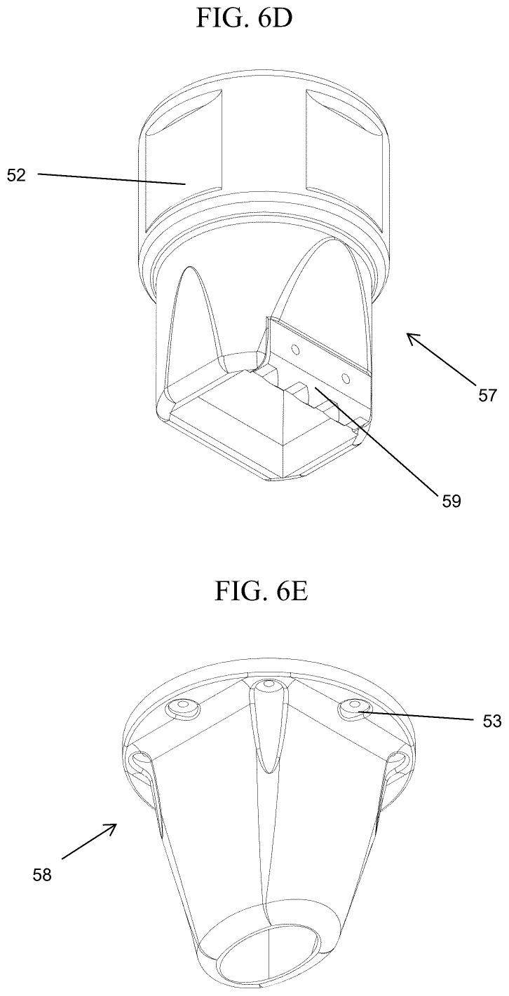

Each subsystem that is an extruder subsystem may include a material pipe 39, which optionally may include an auger 48 rotated by auger motor 46 in auger mount 47 (FIGS. 6A-6C). In use, material may enter the extruder subsystem via inlet 32, which is fluidly connected to material pipe 39. Material may enter from the material hose 36 through material inlet 32. In some embodiments, the system includes an extruder subsystem, such as exemplary extruder subsystem 30 (FIG. 3), that includes a leveling puck 34 positioned at a distal end of the material pipe 39. Exemplary extruder subsystem 30 may be used for subterranean footing printing. Material pipe 39 may include an extended material pipe 33 configured to reach subterranean depths. Puck 34, optionally a vibrating puck via vibrators 35, may allow for the leveling of subterranean material such as the footings 180. In certain embodiments, the puck 35 may be removable from the extruder subsystem 30. Removal of the puck 34 may allow for a nozzle to be fitted to the distal end of material pipe 33. In certain embodiments, material pipe 33 may be removable from the extruder subsystem. Removal of the material pipe 33 may allow for a nozzle to be fitted to the disconnect 37 (FIG. 4).

In some embodiments, the system includes an extruder subsystem, such as exemplary extruder subsystem 40 (FIG. 4), that includes nozzle tip 41 positioned at a distal end of the material pipe 33. Exemplary extruder subsystem 40 may be used for printing foundation walls, e.g., subterranean foundation walls.

Material pipe 33 can be selected to have a desired length to accommodate different depths of printing. In certain embodiments, material pipe 33 may be varying lengths, for instance, in some embodiments, material pipe 33 may be a telescoping pipe or may be made extendable by incorporating additional pipe segments. In some embodiments, for example, for subterranean printing, material pipe 33 may have a length selected to reach subterranean depths. The length of material pipe 33 may allow printing at least 12 inches, at least 15 inches, or at least 23 inches, or more below the undisturbed surface of the soil. In the case of basement printing, the length of the material pipe 33 may allow printing at least 8 feet, 10 feet, 12 feet or more below the undisturbed surface of the soil.

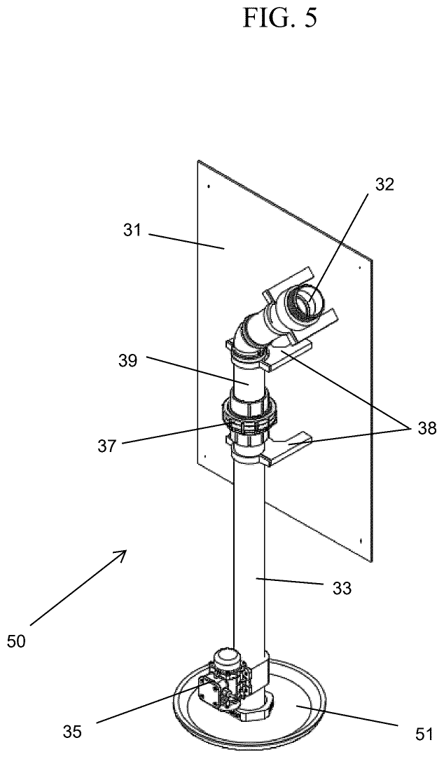

In some embodiments, the system includes an extruder subsystem, such as exemplary extruder subsystem 50 (FIG. 5), that includes slab puck 51 positioned at a distal end of the material pipe 33. Optional vibrators 35 may assist in the leveling of the material. Exemplary extruder subsystem 50 may be used for printing slab. Slab printing puck 51 may optionally be flexible to allow for navigation around obstacles in the slab, such as conduit stub ups 203 for electrical wiring, without damage to the nozzle or extruder upon collision. In use, slab puck 51 or other angled attachments may mimic a screeding action traditionally performed with manual tools in conventional construction.

In some embodiments, the system includes an extruder subsystem, such as exemplary extruder subsystem 60 (FIGS. 6A-6B), that may include a rotary joint 64 to allow for tangential rotation. The rotary joint 64 may enable rotation of the material pipe 39 or nozzle for directional printing. The extruder subsystem may print clean, non-circular profiles. The extruder subsystem may be held by support bearing 66. Gear assembly 61, which includes gears connected by rotary belt 62 and tangential motor 63, may be mechanically connected to rotary joint 64, enabling rotation. Tangential housing sensor 65 may sense positioning of the material pipe 39 or nozzle and may optionally be operably connected to control box 8. Pinch valve 26 may be used to prevent material from leaking out of the nozzle at unwanted times while printing, and may be used with any extruder configuration. Extruder subsystem 60 may or may not include an auger 48 to assist in the conveyance of material.

Extruder subsystem 60 may include a nozzle, such as a non-circular nozzle fluidly connected to material pipe 39. Exemplary non-circular nozzles include rectangular nozzle 57 (FIG. 6D) and oval nozzle 58 (FIG. 6E), but other non-circular apertures may be used, such as pentagonal or irregular apertures. In other embodiments, the nozzle may have a circular aperture. Exemplary extruder subsystem 60 may be used for printing interior or exterior walls. In some embodiments, nozzles may have teeth 59 used to produce serrations in the top layer of the bead while printing. Serrations may further lock printed layers together by forming a key and preventing water infiltration. Nozzles may be attached by a bolted attachment 53 or threaded attachment 52 to the extruder at nozzle attachment point 68.

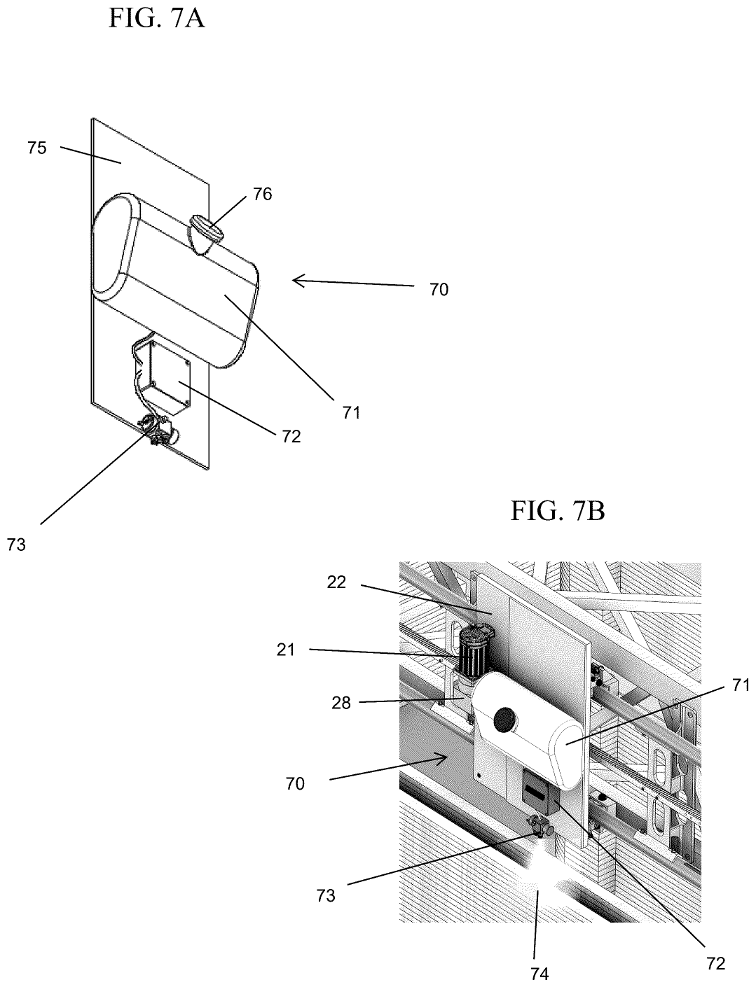

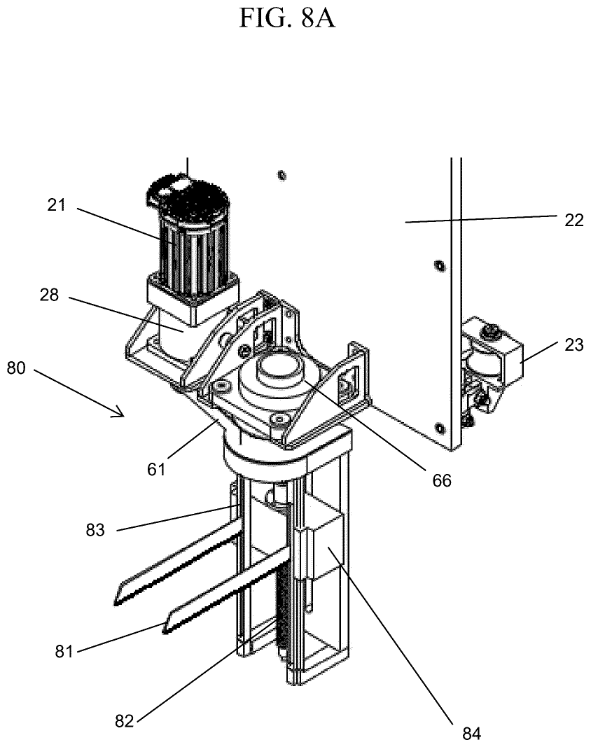

In some embodiments, the system may include gluing apparatus 70 (FIGS. 7A-7B). The gluing apparatus 70 may include a glue sprayer 73 mechanically connected to gluing solenoid and pump box 72. Sprayable liquid adhesive, such as glue 74, may be stored in tank 71 fluidly connected to glue sprayer 73. Inlet 76 of tank 71 may be used to fill tank 71 with liquid adhesive or may be fluidly connected to a source of liquid adhesive. In some embodiments, inlet 76 may be sealed by a storage tank cap. Gluing apparatus 70 may be mounted to x-axis carriage 20, for example, mounting plate 75 may be mountable to base plate 22 or another location, with or without an extruder subsystem.

FIG. 7B shows gluing apparatus 70 in use depositing glue 74 on 3D printed walls 220. The gluing apparatus 70 may be used when a period of time has elapsed between printed beads to ensure that there are no cold joints or delamination of the printed layers.

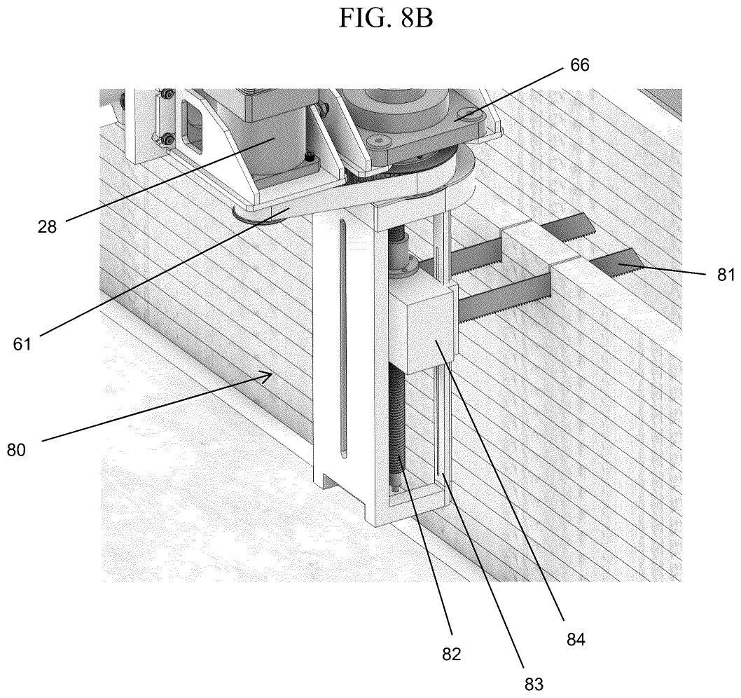

In some embodiments, the system may include slicing apparatus 80 (FIGS. 8A-8B). The slicing apparatus 80 may include blades 81 controlled by mechanism 84. The blades may optionally be reciprocating or vibrating blades. The exemplary slicing apparatus 80 includes two blades, however the slicing apparatus may include one or more than two blades, e.g., three, four, five, six, or more blades. The slicing apparatus 80 may include a piston or lead screw 82 that moves blades 81 up and down on rails 83. Slicing apparatus 80 may be mounted to x-axis carriage 20, for example, mountable to base plate 22 or another location. The apparatus may be attached to the tangential rotation mechanism with rotary gear assembly 61 to allow rotation of the slicing apparatus 80, enabling slicing in any orientation. The slicing apparatus 80 may be used to slice print segments, for example, for placement of electrical boxes, as seen in FIG. 8B.

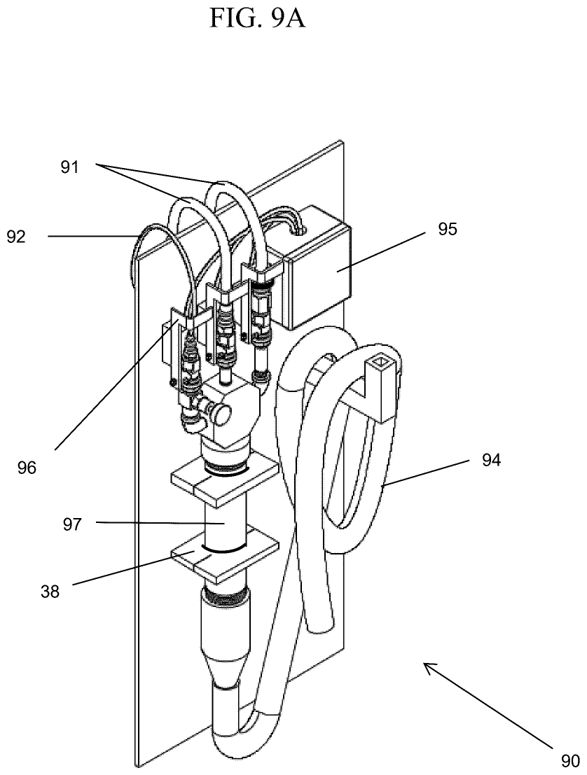

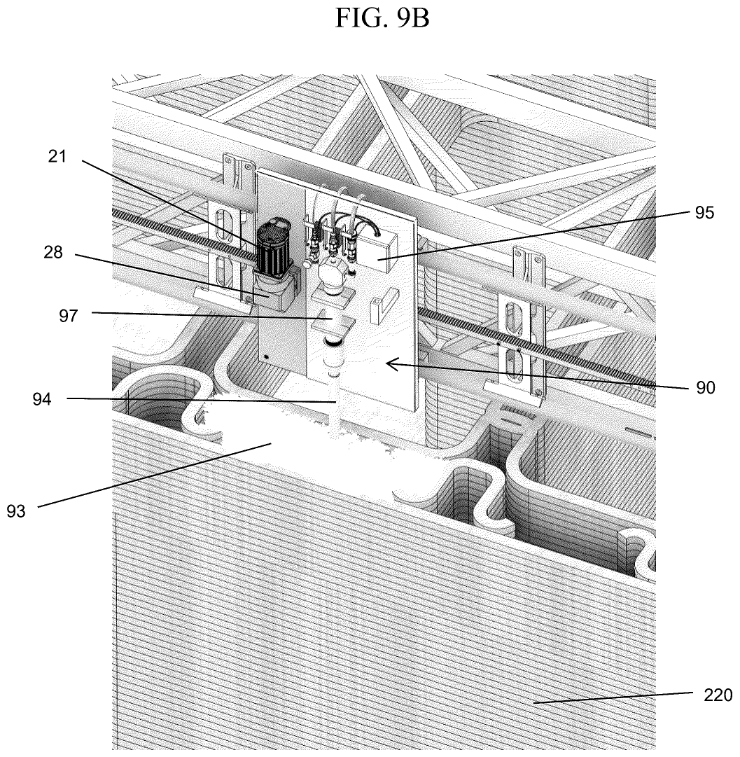

In some embodiments, the system may include an insulation subsystem, such as exemplary insulation subsystem 90 (FIGS. 9A-9B). The insulation subsystem 90 may be fluidly connectable to an insulation trailer storing insulation material or chemicals to be mixed at the extruder. In certain embodiments, the insulation trailer may be configured to pump insulation to the insulation nozzle 97. In other embodiments, the insulation trailer may be configured to pump chemicals through hoses 91, 92 to the insulation nozzle 97, which may be a mixing nozzle. The insulation trailer may be configured to pump insulation through a hose 84 to an insulation dispenser 82. The insulation dispenser 82 may have varying lengths and may deliver the insulation into the walls. Insulation subsystem 90 may be mounted to x-axis carriage 20, for example, mountable to base plate 22 or another location.

The insulation mixing nozzle 97 may have varying lengths and may be fluidly connected to hose 94 configured to deliver the insulation into the walls. Weights may be added to hose 94 to ensure that the hose reaches the bottom of the wall void when in use. When not in use, hose 94 may be coiled for storage as shown in FIG. 9A. Solenoid control box 95 may be used to open the valves to mix the insulation in the nozzle mixing chamber 97. Solenoid control box 95 may be controlled remotely through the push of a button or manually through actuation of control levers 96. Air hose 92 may be used to move the insulation through the system using a compressor. FIG. 9B shows the insulation subsystem 90 in action, filling the void between two printed wall surfaces with insulation 93. The insulation subsystem 90 may utilize closed cell or open cell insulation, or other types of flowable insulation.

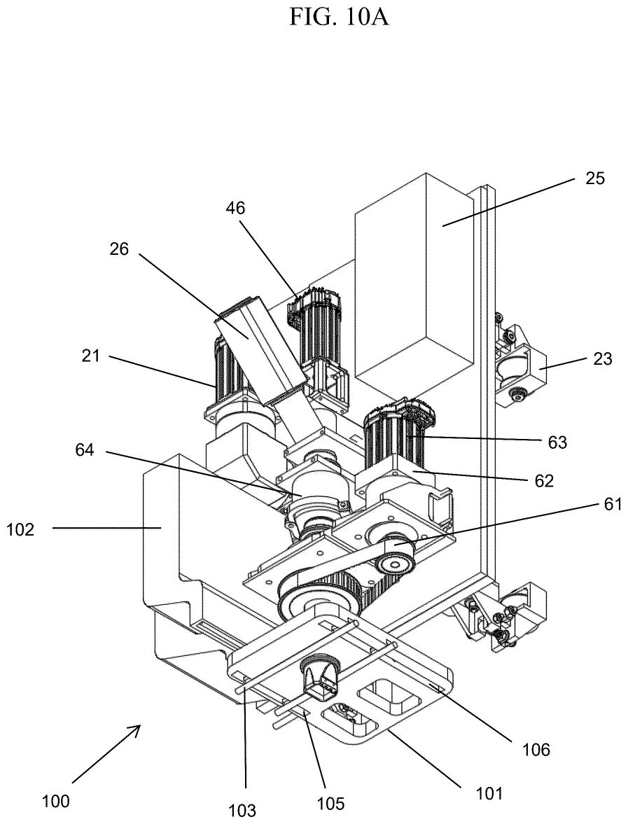

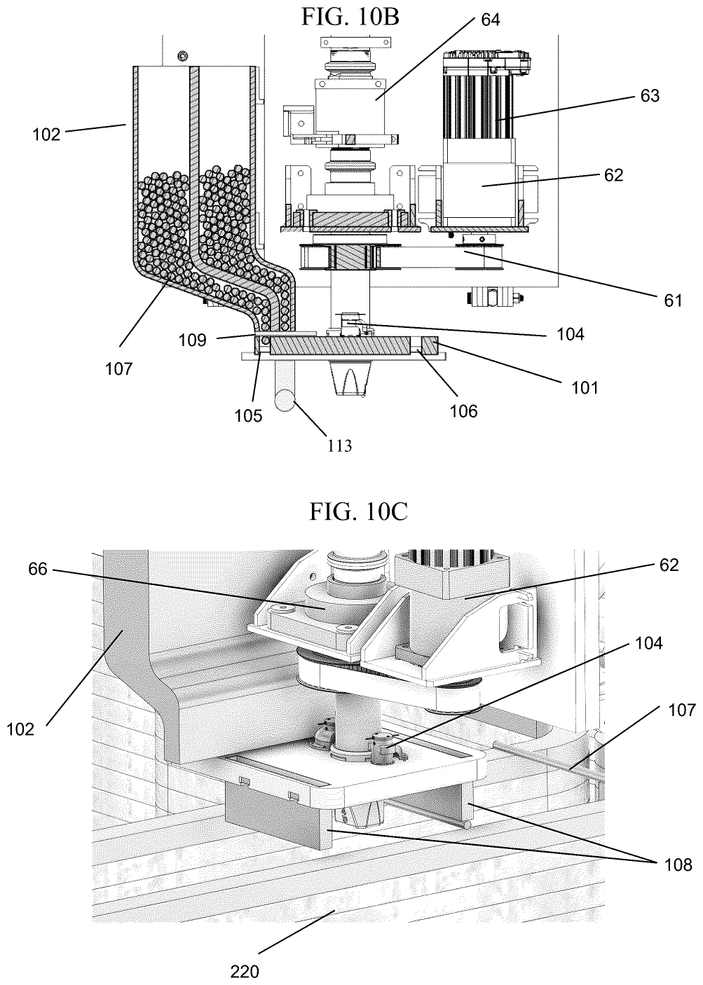

In some embodiments, the system may include a rebar subsystem, such as exemplary rebar subsystem 100 (FIGS. 10A-10C), that may be used to install (e.g., drop and embed) rebar between 3D printed beads to allow for reinforcement. For example, as shown in FIG. 10C, rebar subsystem 100 may drop and embed rebar 107 between two printed wall surfaces. Rebar dispenser guides 108 may be mechanically connected to rebar subsystem motor 104. In use, rebar orienter plate 101 may be rotated by tangential rotation mechanism, e.g., gear assembly 61, to allow for rebar dispensing in different directions.

Rebar hopper 102 may store rebar of multiple lengths, as seen in the cross-sectional view of FIG. 10B. When required, the orienter plate 101 may rotate to the appropriate dispensing slot, for example, small rebar dispensing slot 105 or large rebar dispensing slot 106, such that a piece of rebar may be released from the rebar storage hopper 102 by activation of sliding hopper release mechanism 109. Rebar orienter plate 101 may then rotate to an orthogonal position to the printed beads to dispense rebar. Rebar dispensing lever 103 may be actuated by activation of rebar dispensing motor 104, dropping rebar into place. The rebar subsystem 100 may optionally include rebar dropping guide 108 to guide the dispensed rebar (FIG. 10C). The rebar subsystem 100 may optionally include rebar embedding tab 113 to further embed the rebar into the printed bead, should the effects of gravity not cause the rebar to be sufficiently embedded in the printed beads.

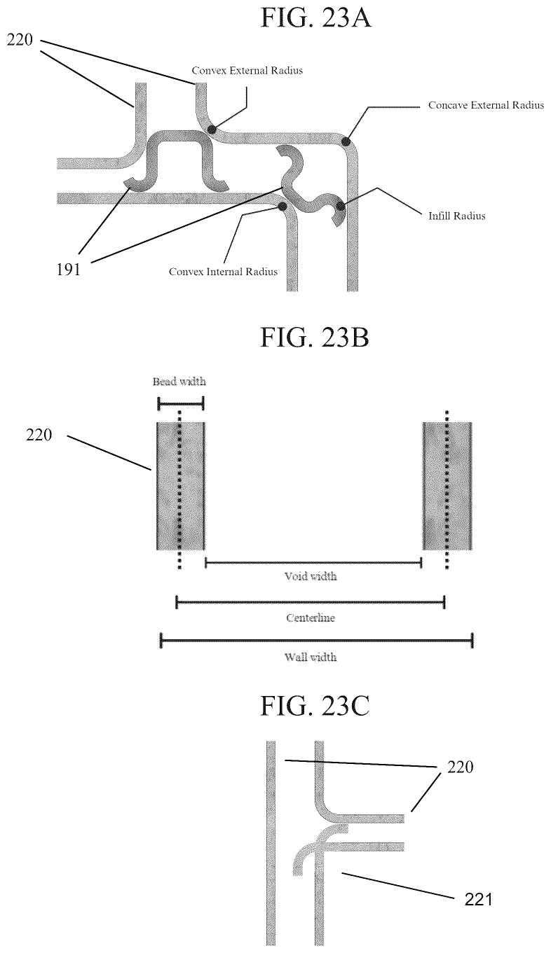

Rebar subsystem 100 may be mounted to x-axis carriage 20, for example, mountable to base plate 22 or another location. The rebar subsystem 100 may be mounted to the carriage simultaneously with an extruder subsystem, such as tangentially rotating extruder subsystem 60, so rebar dropping may happen simultaneous with printing. X-axis carriage 20 may move rebar subsystem 100 to the appropriate location for dispensing rebar between the wall surfaces, for example, in accordance with G-code. In certain embodiments, rebar may be dispensed during printing of infill (FIGS. 23A-23C), such that the inner and outer bead wall surfaces may be at the same height so the rebar is level when placed.

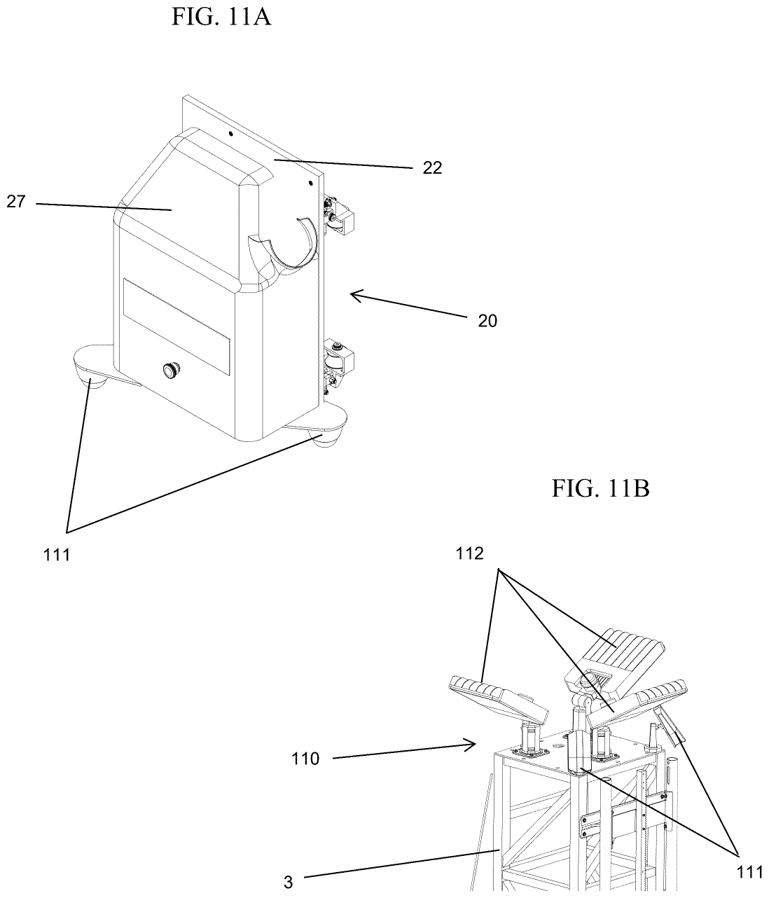

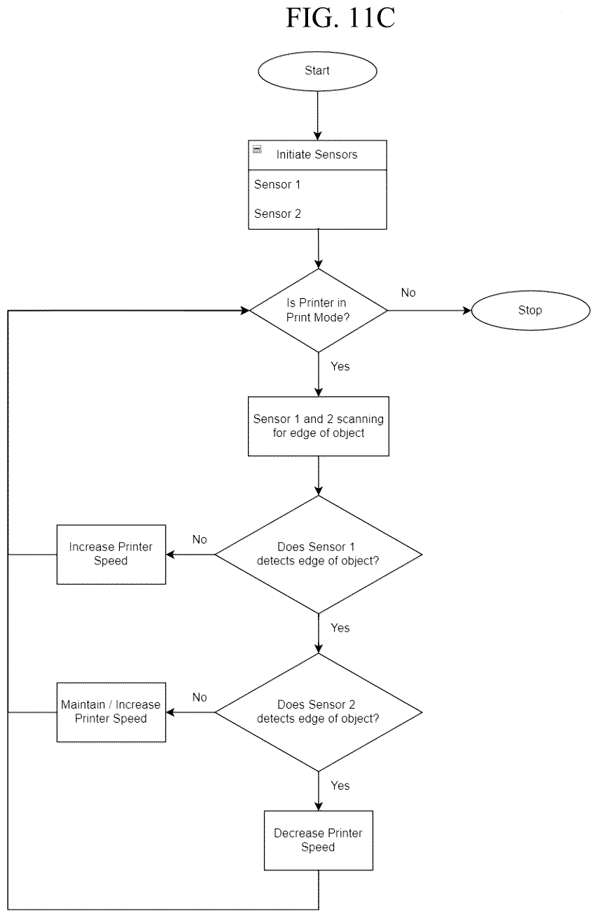

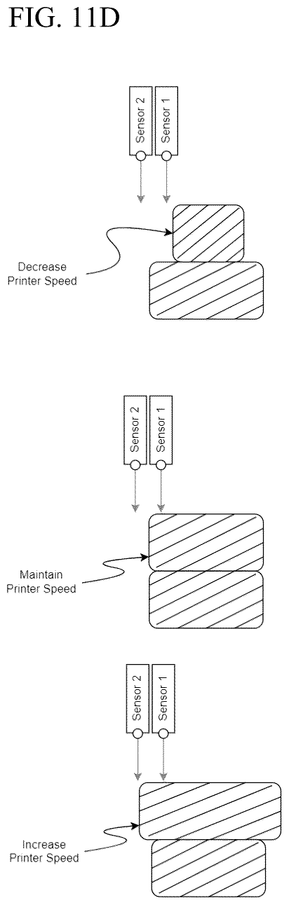

In some embodiments, the system may include one or more cameras 111, as shown in FIGS. 11A-11B. The cameras 111 may allow for photo and/or video monitoring of the construction print. The camera 111 may be operably connected to a control panel. In some embodiments, the camera 111 may be operably connected to a network to allow for remote monitoring. The camera 111 may be positioned on the x-axis carriage 20 (FIG. 11A), z-towers 111 (FIG. 11B) on camera and lighting plate 110, or elsewhere. The cameras 111 may be positioned adjacent an extruder subsystem or may be incorporated in their own camera subsystem mountable to the x-axis carriage 20. The extruder subsystem may optionally comprise an extruder plate cover 27. In some embodiments, the camera 111 may be operable to pan or tilt in one or more planes, zoom in or out, record, take still photos, etc.

In some embodiments, the system may include one or more lights 112 to illuminate the build project and/or the construction site. The lights 112 may be positioned on the x-axis carriage 20 (not shown), z-towers 3 (FIG. 11B), or elsewhere on the printer or construction site. The lights 112 may be configured to illuminate construction site. In some embodiments, the lights 112 may be operably connected to a control panel. In some embodiments, the lights 112 may be operably connected to a network to allow for remote activation.

In some embodiments, the camera 111 and/or lights 112 may be connected to a cellular network. In some embodiments, the camera 111 and/or lights 112 may be connected to a network via WiFi connection. Thus, in certain embodiments, the system may include a signal extender, such as a WiFi extender.

In some embodiments, the cameras 111 may be programmed for recording of the process and viewing for inspection purposes. The cameras 111 may be programmed for continuous recording or intermittent recording. In traditional construction processes, there are many mandated inspections that cause significant downtime in the build process, preventing continuous operation.

It is believed that use of the system described herein may allow for updates in the methodology of government and town building inspections. For instance, continuous recording and playback may be used to reduce the frequency and/or length of pauses that are typically taken to allow for inspections.

In some embodiments, the construction 3D printing system may include mechanisms and components that are very quiet while in operation. Such components may allow printing in off-hours, and optionally around the clock. For instance, the systems disclosed herein may contain noise dampening elements to allow for quiet operation of heavy machinery.

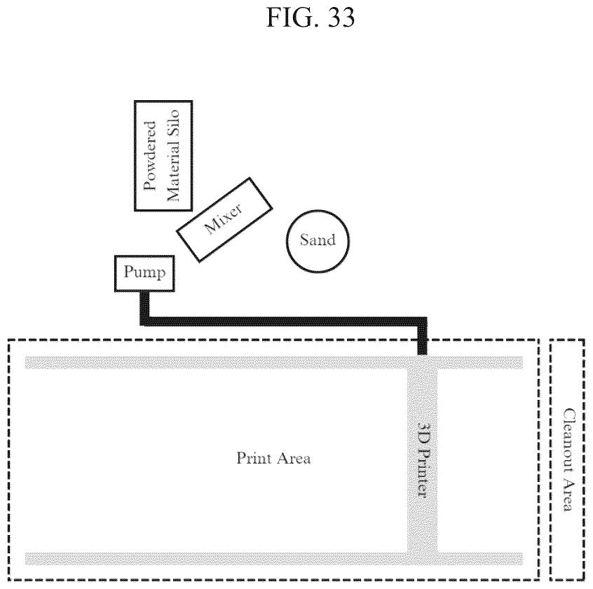

The system disclosed herein may further include volumetric mixer and pump as depicted in FIG. 33, a box diagram showing a typical site layout. The volumetric mixer may be fluidly connected to a dried material silo comprising cement powder or other powder material. A source of sand and/or stone and/or one or more sources of admixtures may also be fluidly connectable to the volumetric mixer. In use, the powder material may be delivered to the volumetric mixer, for example, dropped from the shoot of the silo into the volumetric mixer, where it may be combined with sand and/or stone, and, optionally, one or more other admixtures.

The volumetric mixer may be configured to mix the material to form the building material. The amount of powder material and admixture used to produce the building material may be selected responsive to the part of the structure being constructed. Thus, in some embodiments, properties of the building material, such as viscosity and composition, may be selected based on the component of the structure being printed. The building material may be varied in real time to produce the appropriate material consistency for each component of the structure. The freshly mixed on-demand building material may then be directed by the pump through the hosing to an extruder subsystem, according to the build protocol.

The building material may be a cementitious material or concrete. In some embodiments, the building material may be a structural cementitious material. In certain embodiments, the building material may be an engineered material. Cementitious materials and concrete may refer to building material that is capable of producing load bearing structures. Structural cementitious material may refer to building material that is used in the creation of permitted buildings and structures.

Engineered building material may refer to material that has been tested and approved, optionally by a regulatory body. In certain embodiments, the concrete or cementitious material may be certified by the American Concrete Institute (ACI). In some embodiments, the concrete or cementitious material may be a material having properties certified by the American National Standards Institute (ANSI) and/or the American Society for Testing and Materials (ASTM).

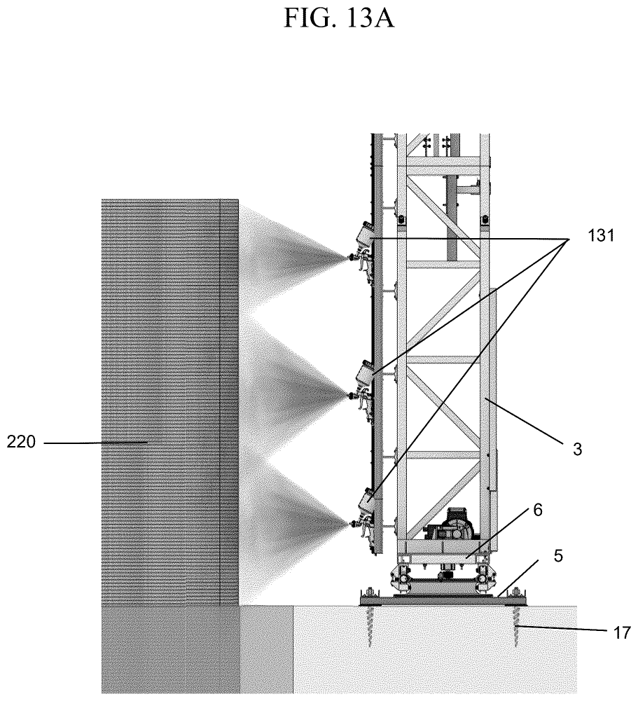

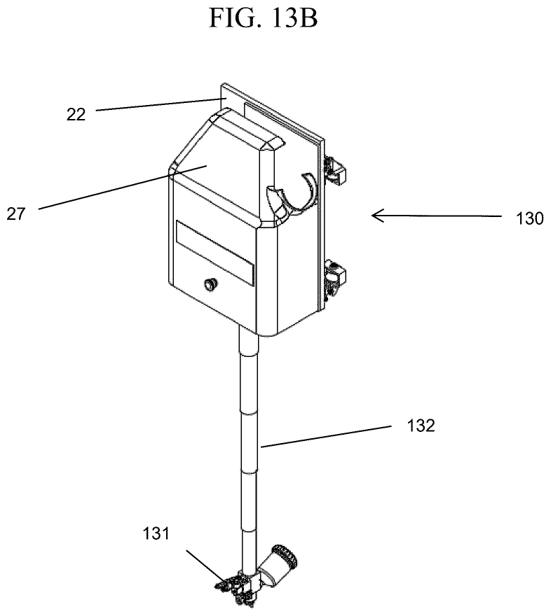

The system may include a paint spraying apparatus 130 (FIGS. 13A-13B). The paint spraying apparatus 130 may be mountable to the z-axis towers 3 (FIG. 13A) or the x-axis carriage 20 (FIG. 13B). The paint spraying apparatus 130 may include one or more paint sprayers 131, e.g., one, two, three, four, five, six, ten, twenty, or more paint sprayers. In some embodiments, each paint sprayer 131 may be fluidly connected to an individual source of paint, e.g., a paint hopper. In other embodiments, a plurality of paint sprayers 131 may be fluidly connected to a common source of paint, e.g., by a hose and pump. The paint apparatus 130 may include a manifold to direct the paint to the paint sprayers 131. In exemplary embodiments, the z-axis tower 3 paint sprayers 131 may be used for exterior walls. In exemplary embodiments, x-axis carriage 20 paint sprayer 131 may be used for interior rooms and other exterior walls.

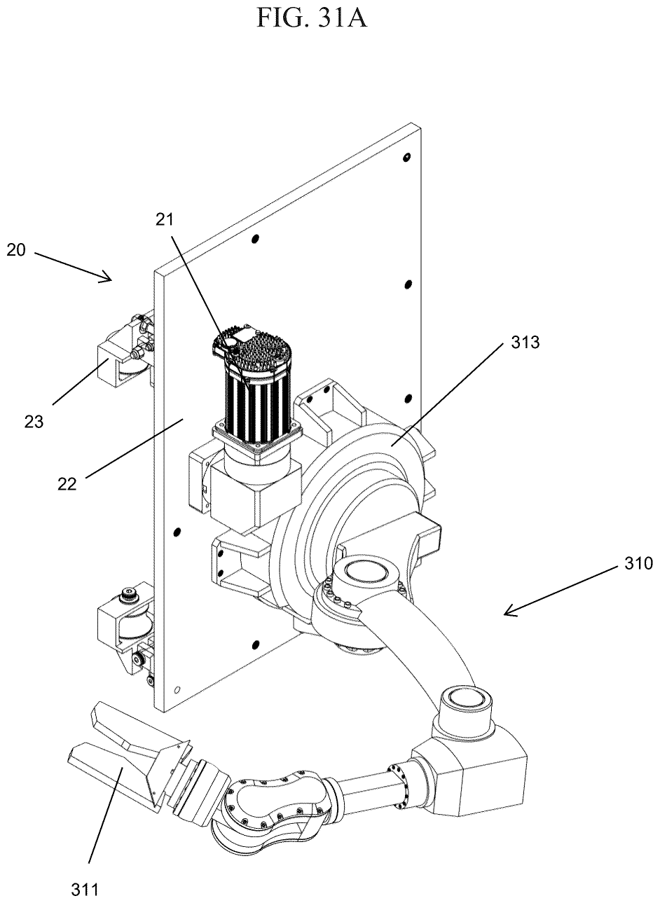

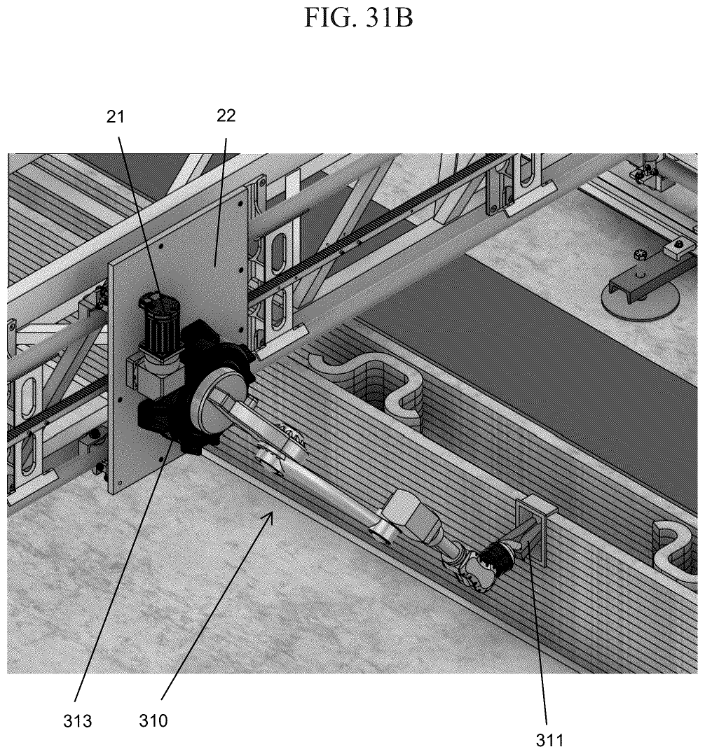

As shown in FIG. 3B, in some embodiments, the paint spraying apparatus 130 may be mountable to the x-axis carriage 20, for example, on base plate 22. The paint spraying apparatus 130 may include a rotatable tube 132 mechanically connecting the paint sprayer 131 to the mounting plate. Optionally, the rotatable tube 132 may be telescoping to facilitate up and down movement of the paint sprayer 131. In some embodiments, the paint sprayer 131 may be mounted to a robotic arm 310 (for example, as shown in FIG. 31A) to move or control the spray paint apparatus 130, with or without rotatable tube 132. The paint spraying apparatus 130 may be moved around by the x-axis carriage 20 and y-axis tracks 5 in any direction according to a protocol or responsive to remote manual operation.

In certain embodiments, the system may include a robotic arm attachment 310 (FIGS. 31A-31B). In certain embodiments, the robotic arm 310 may include grabbers 311 at a distal end for grabbing items and performing tasks, such as installing fixtures (FIG. 31B). In other embodiments, the robotic arm may include another type of receiver or fastener. The robotic arm 310 may include a base 313 that is mountable to x-axis carriage 20. The robotic arm 310 may be operated through a user interface. In certain embodiments, the robotic arm 310 may be operably connected to the control box 8 and operable through the control box 8 user interface. In certain embodiments, the robotic arm 310 may be connectable to a network and operable remotely through its own user interface.

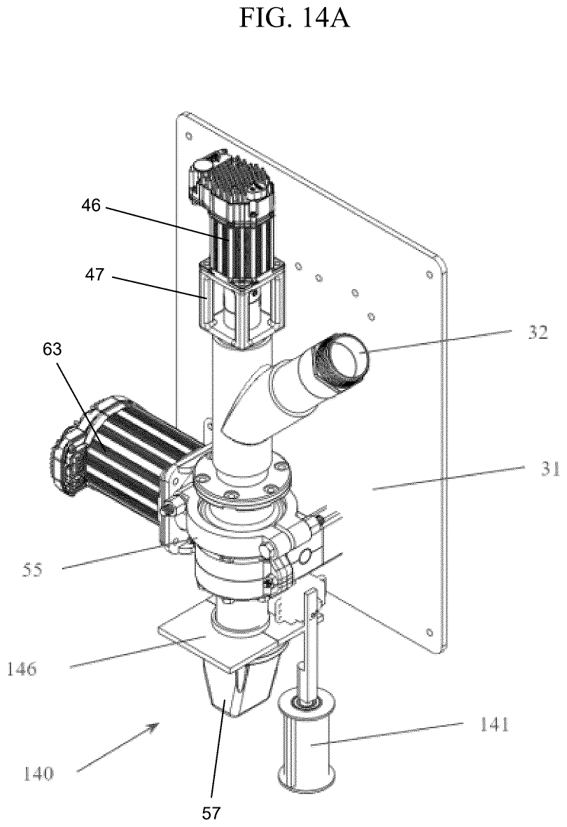

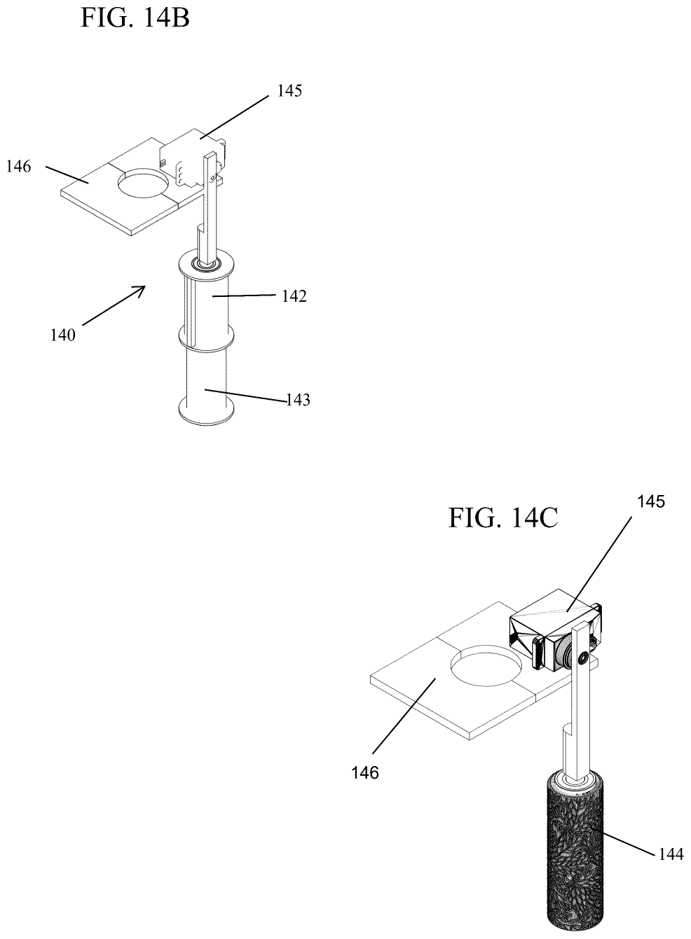

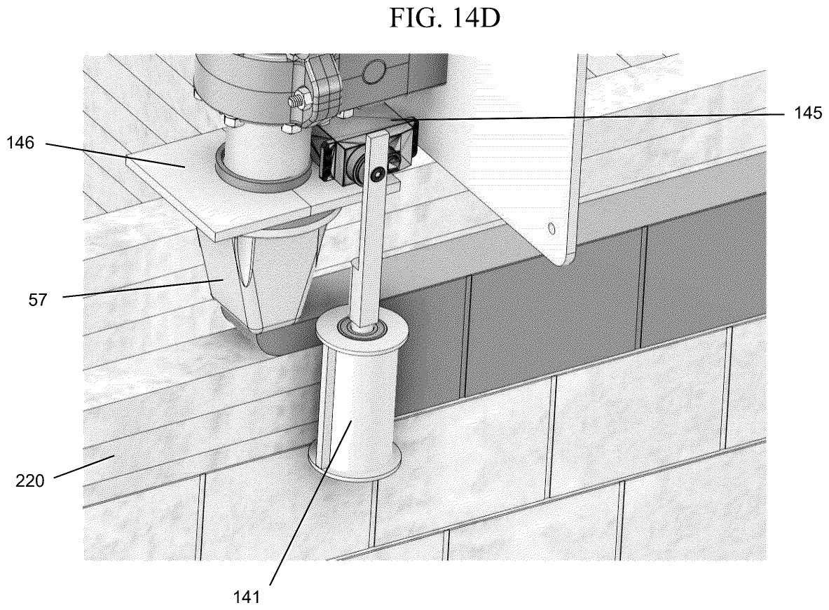

In some embodiments, the system may include a rolling attachment 140 (FIGS. 14A-14D). The rolling attachment 140 may be mounted adjacent an extruder subsystem, e.g., adjacent a nozzle (FIG. 14A). The rolling attachment 140 may be rotated by tangential rotation mechanism, e.g., gear assembly 61, including meshed gears for tangential motion 55. The rolling attachment 140 may be used to apply unique patterns and textures to the 3D printed wall. The rolling attachment 140 may be used to modify the 3D printed wall, without a later need for stuccoing or other textured application, which can be expensive, time consuming, and wasteful of material. The roller may have any number of unique rolling or stamping patterns or textures, such as smooth roller 141 (FIG. 14A), brick facade roller 142 (FIG. 14B), extender 143 (FIG. 14B), or another unique or custom pattern 144 (FIG. 14C). The extender 143 may be used with any roller.

The rolling attachment 140 may include a motor 145. The rolling attachment motor 145 may rotate to swing the rolling attachment 140 into position, and then may rotate back upwards to move the roller out of the way of printing operations. Bracket 146 may be used to attach the rolling attachment 140 to the extruder pipe of an extruder subsystem (FIG. 14A), such as to a material pipe 39. Optionally, a water sprinkler may be positioned at the roller, or a small material delivery port may be positioned to provide extra material to ensure that the desired textured material covers the area. FIG. 14D shows a close-up of the rolling attachment 140 in action, providing a brick pattern to the printed material.

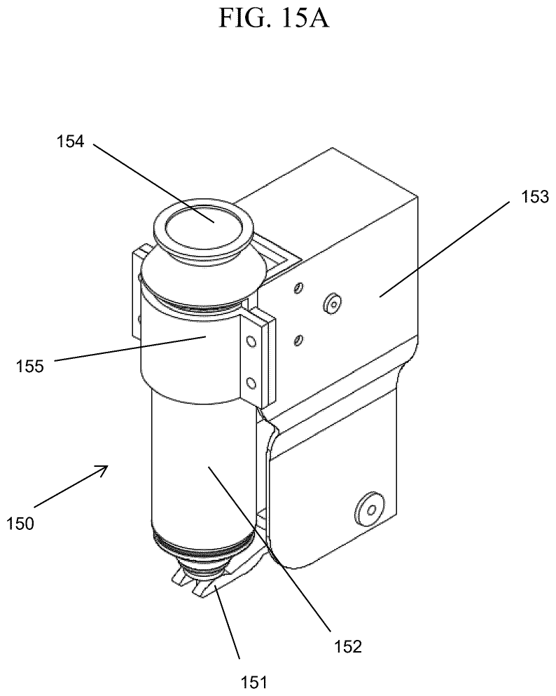

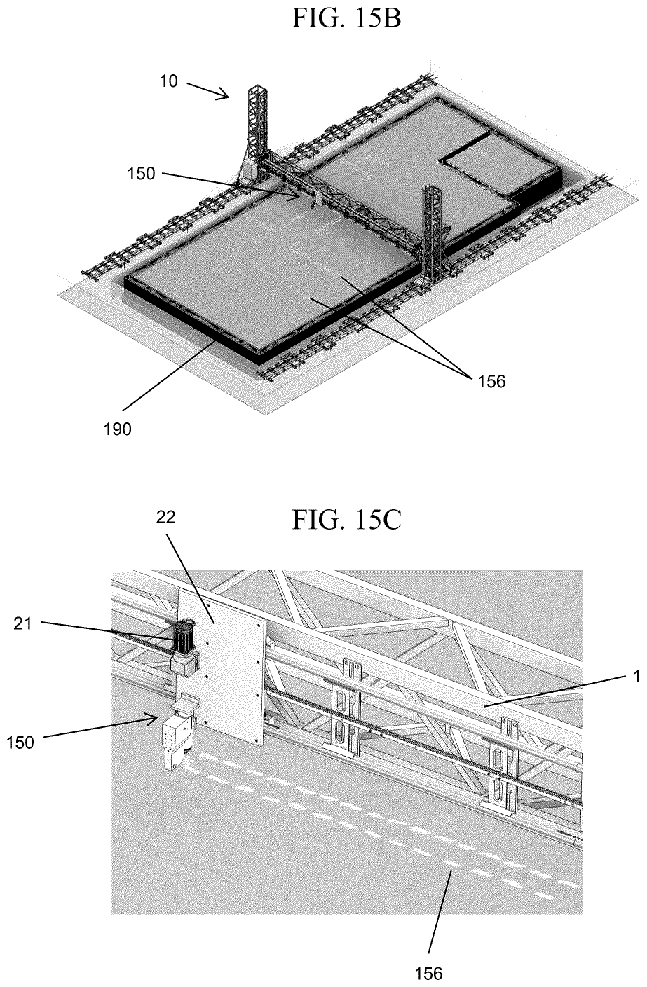

In some embodiments, the system may include a mark-out apparatus 150 (FIGS. 15A-15C). The mark-out apparatus may include a paint can, such as a spray paint can 152. The spray paint can 152 may be activated by lever 151 which may be controlled by solenoid control encasement 153. The mark-out apparatus 150 may be mountable to the x-axis carriage 20 via attachment point 154. The spray paint can 152 may be held in by clamp 155. Spray painted lines 156 may be used to mark out any number of building related locations, such as the location of interior walls, conduit stub-ups, plumbing locations, outlets, and more, as shown in FIGS. 15B-15C.

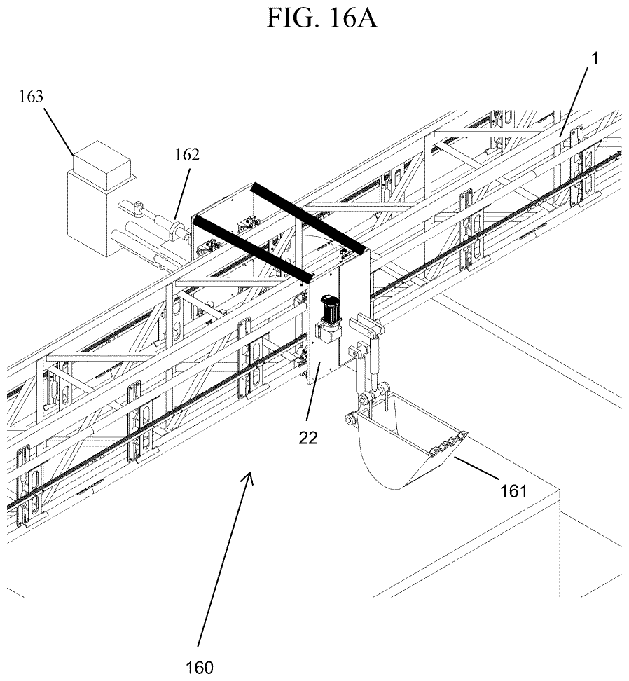

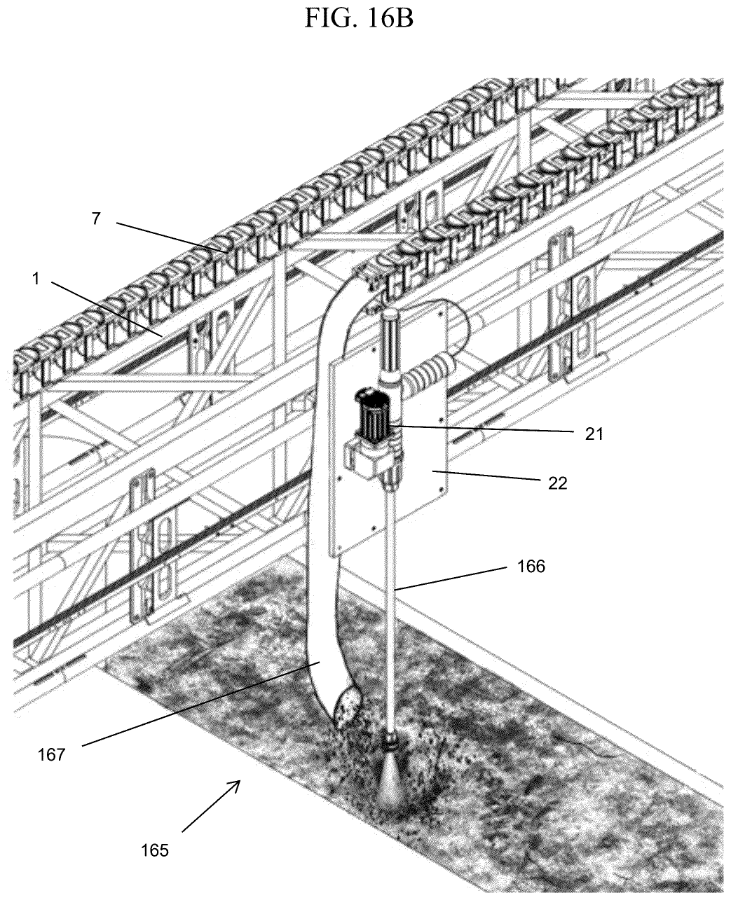

In some embodiments, the system may include a digging apparatus 160 (FIG. 16A) that may be used to excavate and drill trenches in the ground for subterranean printing. The digging apparatus may include an excavation bucket 161 mechanically connected to a plurality of hydraulic cylinders 162 to dig into the soil. Adjustable counterweights 163 may be attached to the printer, e.g., on the x-axis gantry 1, opposite the digging apparatus 160 to stabilize the gantry and prevent tipping over during excavation. As the balance may shift based on the load exerted by the soil on bucket 161, a counterweight mechanism, placed perpendicular to the force of gravity, may provide adjustments to the position of the counterweights 163 to accommodate various loads and soil conditions that exert highly variable pressure.

The excavation bucket 161 may include teeth. The teeth, mounted on the bucket 161, may assist in penetrating different types of soil. For instance, tougher, more compacted soils generally require stronger or sharper teeth, while looser soils might need broader teeth to maintain efficiency. Thus, in some embodiments, the system may include buckets 161 having different types of teeth.

The hydraulic cylinders 162 may be controlled by solenoids operating in accordance with a protocol that drives the excavation process. The use of G-code may enable the automation of digging patterns and depth, reducing human error and improving consistency.

The counterweight mechanism may adjust the position of the counterweights in real-time to regulate the tripping torque, ensuring the rails, e.g., the x-axis gantry 1, remains stable and preventing tipping under uneven loads. This adaptive counterweight system may be especially beneficial when working with varying soil conditions and different loads, as it continuously compensates for shifts in balance, ensuring safe and efficient excavation.

In some embodiments, the digging function may be achieved by use of a hydro-vacuum excavation system 165 (FIG. 16B) in place or in combination with the digging apparatus 160. The hydro-vacuum excavation system may include a source of water fluidly connected to a high pressure dispenser 166 for the water, and a vacuum 167. The hydro-vacuum excavation system 165 may use high pressure water to loosen dirt, while a vacuum then relocates the freed dirt to form the trench.

In some embodiments, the system may include a basement printing subsystem 170 (FIG. 17). It is noted that in certain instances, a material pipe of a certain length would shake and be unstable, causing variations in the printed beads. Additionally, at certain lengths, a significant amount of unwanted material may come out of the nozzle when no longer printing due to the effects of gravity. Thus, in some embodiments, when printing is required beyond a certain depth, e.g., beyond 2 ft, 3 ft, 4 ft, 5 ft, 6 ft, 7 ft, 8 ft, 9 ft, or 10 ft, a basement printing subsystem 170 may be used.

The basement printing subsystem 170 may include a support truss 171 for subterranean basement printing. The support truss 171 may contain a material hose 36 having inlet 32. Material hose 36 may feed into pinch valve 26 positioned toward the distal end of material hose 36. Material may be printed with a subterranean wall nozzle tip 41 positioned at the distal end of material hose 36, downstream from pinch valve 26. Different nozzle tips and pucks may be attached to material hose 36. For instance, in the case of backfilling slab, slab leveling puck 51 may be used. Support truss 171 may be fixed to a mounting plate 31 for attachment to the x-axis carriage 20.

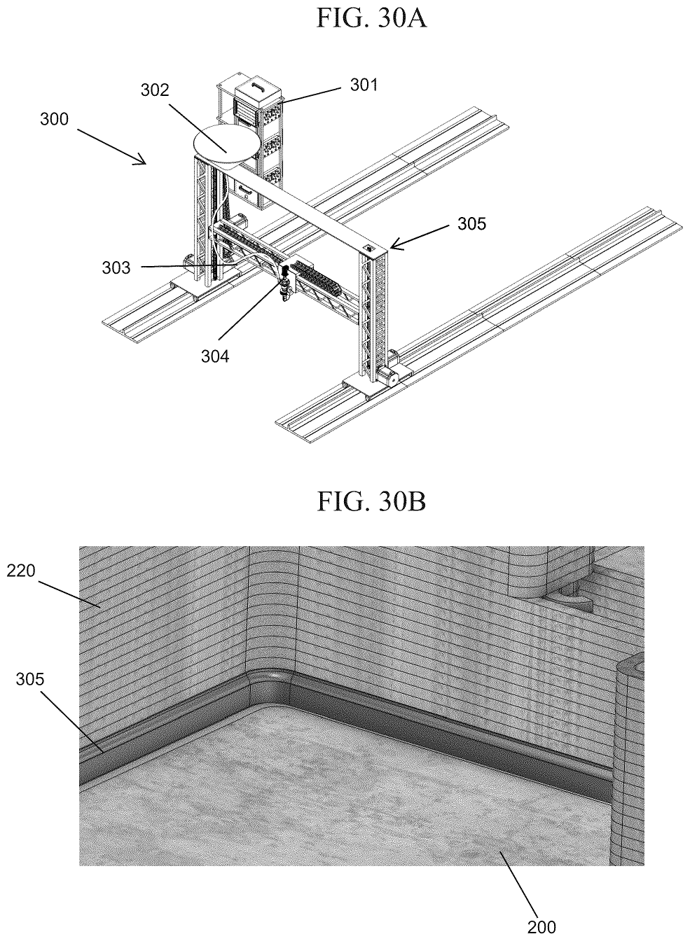

In some embodiments, the system may include a plastic 3D printing subsystem, such as plastic 3D printing subsystem 300 (FIGS. 30A-30B). The plastic 3D printing subsystem 300 may be configured to use a recycled plastic material. The plastic 3D printing subsystem 300 may be used to create fixtures and other accessories, such as, but not limited to, trim, doors, cabinets, and more. The use of a plastic 3D printing subsystem 300 may allow for a greater percentage of the home to be 3D printed, while also drastically cutting costs and optionally preventing or reducing an amount of plastic waste that enters the environment.

The exemplary recycling plastic 3D printer subsystem 300 is configured to use recycled plastic material. The recycling plastic 3D printer subsystem 300 includes a plastic shredder 301 fluidly connectable to a plastic 3D printer 300 on cross-bar 305.

In use, the recycling plastic 3D printer subsystem 300 takes recycled post-consumer plastic, shreds the recycled material into small pieces via plastic shredder 301, and feeds the shreds into a receiver 302 fluidly connected to feed tube 303 having a plastic extruder 304 positioned at a distal end thereof, for dispensing in accordance with a protocol. Cleaning and sorting phases may be scheduled, optionally periodically, before printing.

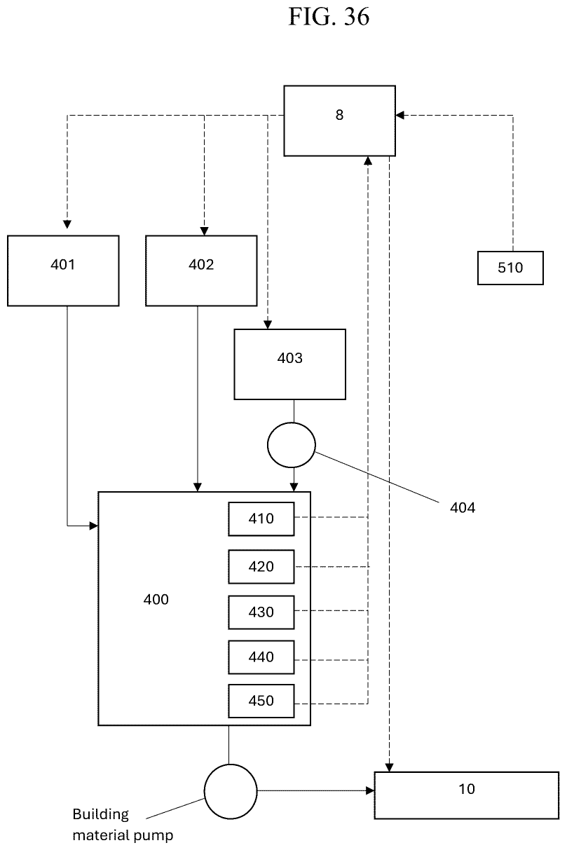

Additionally, the system may include one or more sensor to measure parameters of the building material, construction process, or environment. As shown in FIG. 36, the sensors may be operably connected to control box 8. The system may include one or more sensor positioned to measure a parameter within the volumetric mixer 400, powder material silo 401, source of sand or admixture 402, or source of water 403. Exemplary sensors include a temperature sensor 410, a moisture sensor 420, a water level sensor 430, a powder material level sensor 440, and a sand or admixture level sensor 450. The system may include one or more environmental sensor positioned to measure a parameter of an environment at the build site. One exemplary environmental sensor is a heat and/or light sensor 510.

The volumetric mixer may be manually operated or equipped with sensors to mix and adjust the material ratios automatically without human intervention. In some embodiments, the control box 8, responsive to a measurement obtained from a sensor, may automatically control operation of certain unit functions. For instance, the control box 8 may be programmed to send instructions to a pump or motor responsive to the measurement obtained from a sensor to control building material composition or movement of the x-axis carriage 20. The control box 8 may be programmed to control mixer speed of the volumetric mixer 400 responsive to a measurement obtained from the sensor. In some embodiments, the sensors may be connected to a network, to allow remote monitoring of conditions.

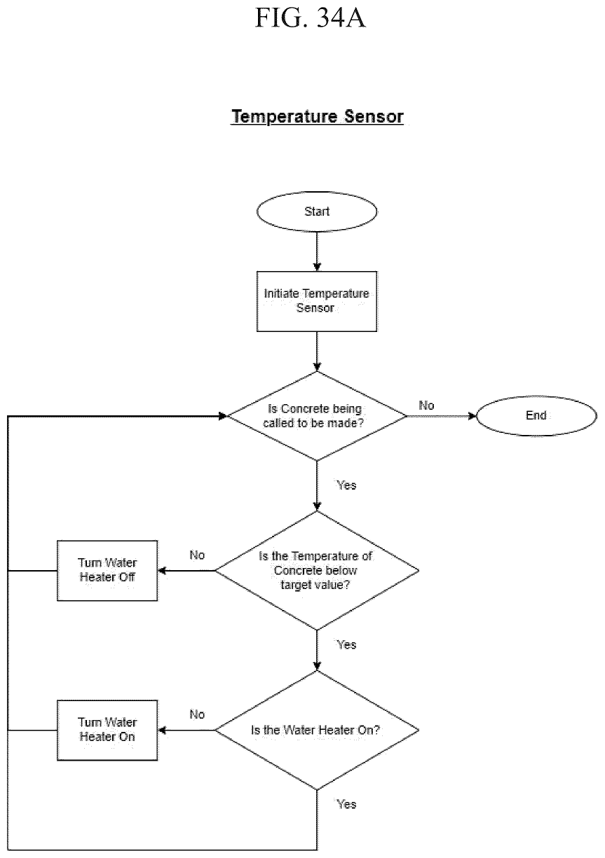

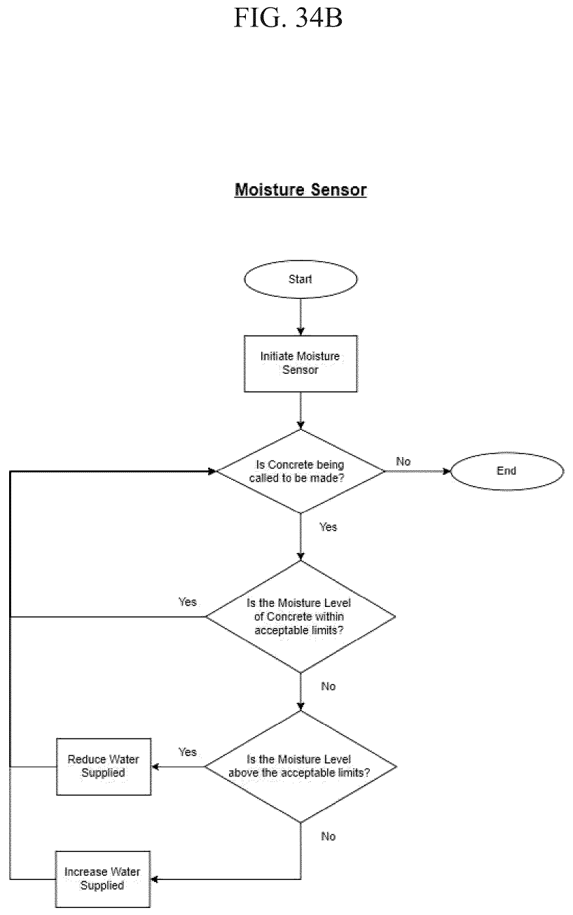

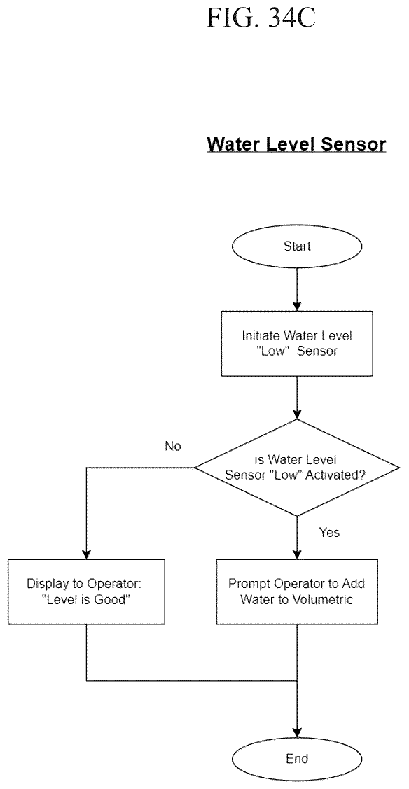

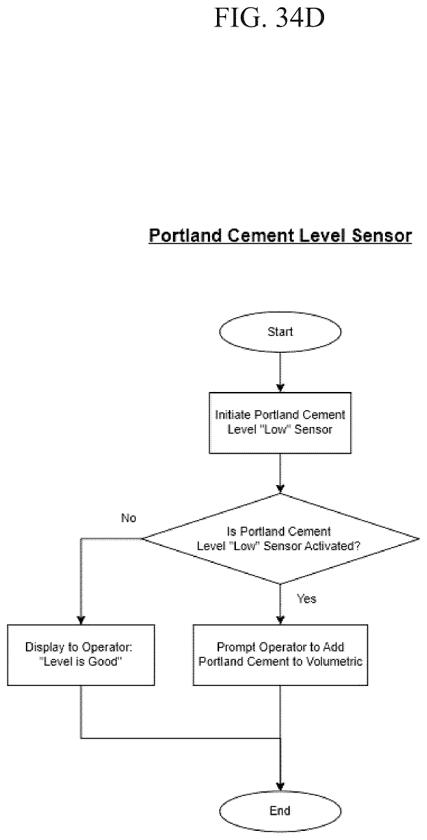

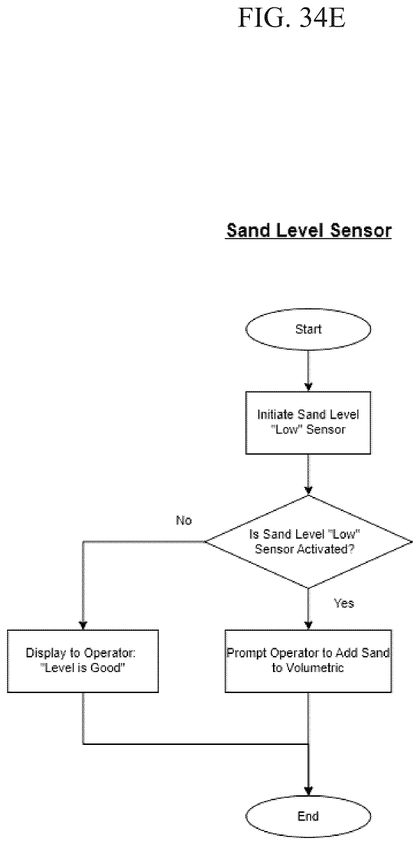

For example, the system may include a temperature sensor 410 positioned to measure temperature of the building material within the volumetric mixer 400. An exemplary control flow diagram for temperature sensor 410 is shown in FIG. 34A. As shown in FIG. 34A, the temperature sensor 410 may be configured to instruct the control box 8 to control temperature of the water fluidly connected to the volumetric mixer 400 (e.g., by controlling a water heater) responsive to a temperature of the building material measured by the temperature sensor 410. The control box 8 may be programmed to activate or deactivate the water heater responsive to the temperature sensor 410.

In some embodiments, the system may include a moisture sensor 420 positioned to measure moisture level of the building material within the volumetric mixer 400. An exemplary control flow diagram for moisture sensor 420 is shown in FIG. 34B. As shown in FIG. 34B, the moisture sensor 420 may be configured to instruct the control box 8 to control flow rate of the water fluidly connected to the volumetric mixer 400 (e.g., by controlling pump 404) responsive to a moisture level of the building material measured by the moisture sensor 420. The control box 8 may be programmed to activate or deactivate the pump responsive to the moisture sensor 420.

In some embodiments, the system may include a water level sensor 430 positioned to measure water level in the volumetric mixer 400. In some embodiments, the water level sensor 430 may be positioned to measure water level within the source of water 403. FIG. 34C is an exemplary control scheme for a water level sensor 430. The control box 8 may be programmed to display to the operator a notification regarding water level responsive to a measurement obtained from the water level sensor 430. In certain embodiments, the control box 8 may be programmed to replenish a water level or add more of water or powder material to the volumetric mixer 400 responsive to the water level sensor 430.

In some embodiments, the system may include a powder material level sensor 440 positioned to measure powder material level in the volumetric mixer 400. In some embodiments, the powder material level sensor 440 may be positioned to measure powder material level within the powder material silo 401. FIG. 34D is an exemplary control scheme for a powder material level sensor 440. The control box 8 may be programmed to display to the operator a notification regarding powder material level responsive to a measurement obtained from the powder material level sensor 440. In certain embodiments, the control box 8 may be programmed to replenish a powder material level or add more of water or powder material to the volumetric mixer 400 responsive to the powder material level sensor 440.

In some embodiments, the system may include a sand or admixture level sensor 450 positioned to measure sand or admixture level in the volumetric mixer 400. In some embodiments, the sand or admixture level sensor 450 may be positioned to measure sand or admixture level within the source of sand or admixture 402. FIG. 34E is an exemplary control scheme for a sand or admixture level sensor 450. The control box 8 may be programmed to display to the operator a notification regarding sand or admixture level responsive to a measurement obtained from the sand or admixture level sensor 450. In certain embodiments, the control box 8 may be programmed to replenish a sand or admixture level or add more water or sand or admixture to the volumetric mixer 400 responsive to the sand or admixture level sensor 450.

The system may include one or more heat and/or light sensor 510 positioned to measure ambient conditions. The heat and/or light sensor 510 may measure temperature, brightness, humidity, or other environmental parameters. In some embodiments, separate sensors may be used to measure one or more of these environmental parameters. The heat and/or light sensor 510 may be utilized to control the speed of the system, e.g., speed of operation or extrusion, based on light and temperature conditions, as light and temperature generally affects the set up or drying rate of the building material. Thus, in certain embodiments, the control box 8 may send instructions to a pump or motor of the system responsive to measurements obtained from a heat and/or light sensor 510.

The control box 8 may be programmed to display to the user or otherwise notify the user of the status of any of the parameters measured by a sensor. In some embodiments, the control box 8 may be programmed to push a notification to the user responsive to a measurement being obtained outside a predetermined threshold, for example, a measurement indicating that a value is too low or too high. The user may be prompted to take action responsive to the notification.

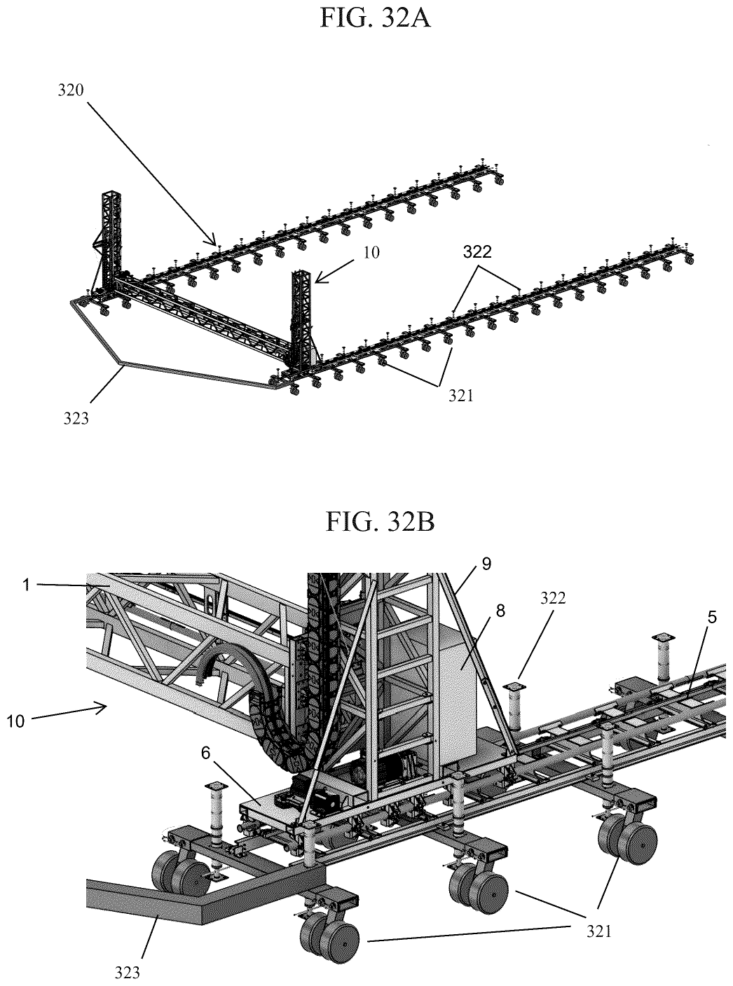

In some embodiments, the system may include a towing apparatus 320 (FIGS. 32A-32B). In certain instances, for example, when printing developments or large projects that may require the repositioning of the machine, using a towing apparatus to relocate the system may significantly improve efficiency, as the system does not need to be broken down and reassembled at the new location. Towing apparatus 320 may include wheels 321 and towbar 322. In some embodiments, wheels 321 may be installed after the printing system has been raised by jacks 322.

In certain embodiments, the system may include one or more sensor for bead width adjustment. The bead width adjustment sensors may be operably connected to control box 8, which may be programmed to adjust bead width responsive to a measurement obtained from the sensor. An exemplary control scheme for the bead width sensors is shown in FIGS. 11C-11D. As shown in FIG. 11C, the sensor may scan for the edge of the bead width. Printer speed may be increased, maintained, or decreased to adjust bead width accordingly.

The construction 3D printing system disclosed herein may include one or more of the described subsystems. The construction 3D printing system may be operated by use of the different subsystems to substantially continuously produce a structure, with minimal to no interruptions during production, which is an improvement over conventional construction methods and even conventional construction printing methods.

### Description of Construction 3D Printing Methods

In accordance with one aspect, there is provided a method of constructing a 3D printed structure, that may be performed with the system described herein.

While the disclosure provides one exemplary numerical order for the steps of a method to produce a 3D printed structure, it should be understood that one or more steps may be performed in a different order or even simultaneously or partially simultaneously. Additionally, in some embodiments, one or more steps may be omitted. In yet other embodiments, one or more steps may be repeated sequentially or non-sequentially.

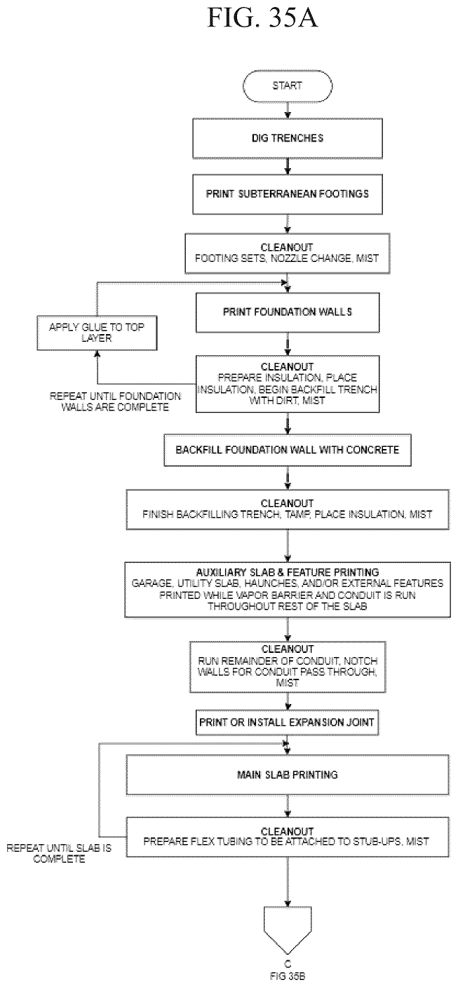

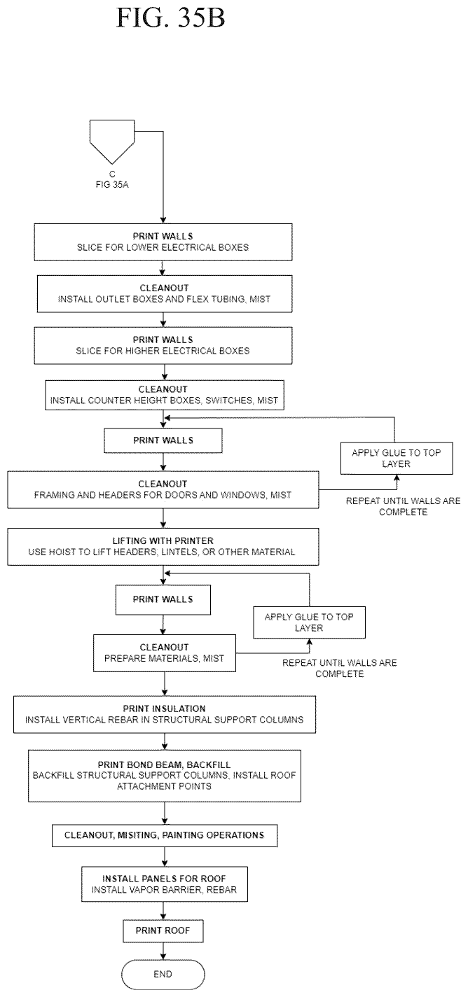

The system disclosed herein may be operated in accordance with a series of programmed functions, which may be followed to build a monolithic structure. In some embodiments, certain steps of the construction printing process may be strategically organized to alternate with hose cleanouts and misting operations, as shown in the exemplary process flow diagrams of FIGS. 35A-35B, to reduce or eliminate any down time of the system.

The methods may include preparing the site for construction 3D printing. The initial preparation of the construction site may be similar to traditional construction. The trench may be excavated to the required depth and width for the given structure. The trench may be excavated with an excavator. In certain embodiments, the trench may be excavated with the construction 3D printer fitted with a digging apparatus 160 or hydro-vacuum excavation system 165, thus removing the need for another large machine on site.

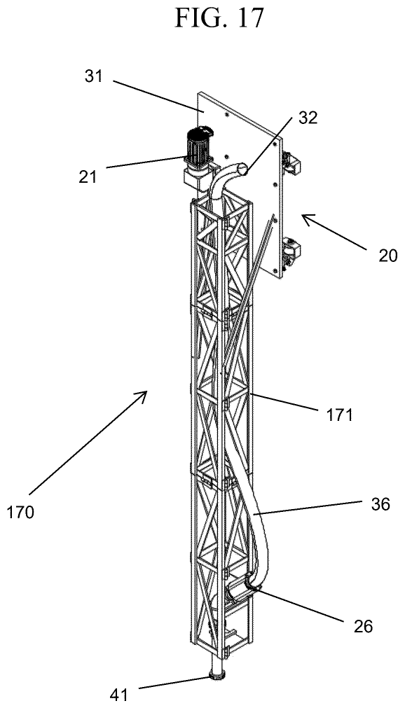

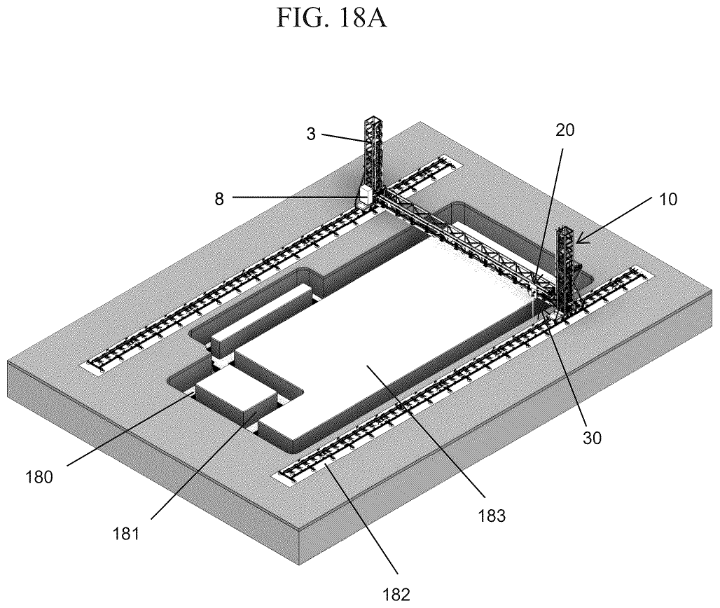

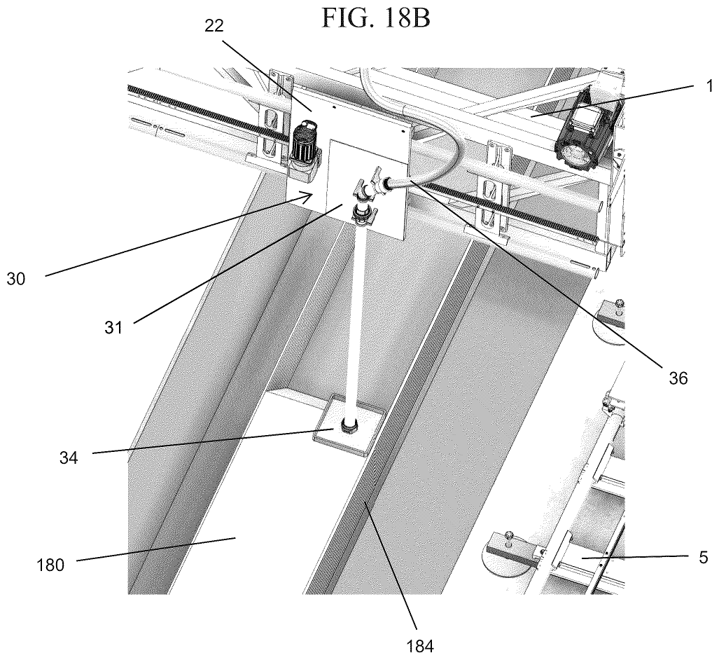

The methods may include forming the construction 3D printer system 10 by assembling the x-axis gantry 1, y-axis tracks 5, and z-axis towers 3 at the construction site. For instance, the methods may include fitting the x-axis gantry 1 to the z-axis carriage 4, fitting the z-axis tower 3 to the y-axis tracks 5, and mounting the x-axis carriage 20 to the x-axis gantry 1. The components may be connected to motor 21 for movement according to a protocol as communicated (automatically or manually) by the control box 8. The methods may include printing a subterranean footing 180 for the structure (FIGS. 18A-18B). As shown in FIGS. 18A-18B, subterranean footings 180 may be printed in trench 181. An optional pad or rollout 182 may be used for y-axis tracks 5. The methods may include forming a tamped pad 183 for slab. The methods may include printing an optional barrier 184 before backfilling the subterranean footings 180 (FIG. 18B).

Unlike in traditional construction, the construction methods disclosed herein may be performed with no forms. The system allows for formless construction, for example, by utilizing a formulation of building material that is printable without forms, reducing waste, time, and material costs. In traditional construction, a form is typically set up and backfilled. A significant amount of time, e.g., up to weeks, must pass for the footing to cure before the forms can be removed and construction is resumed. Hazardous petroleum by-products in gel released by the form can seep into the ground. Thus, the methods and systems described herein that may, in certain embodiments, allow for formless construction, may also be more environmentally friendly.

In certain embodiments, the material for the footing may be deposited directly into the trench, which was dug to have the required dimensions for the structure. In other embodiments, the methods may comprise printing a barrier wall to act as a barrier around a perimeter of the desired footing. The footing building material may then be deposited within the barrier wall. These embodiments may both be performed without a conventional form.

As previously described, the building material may be mixed in real time in accordance with the build protocol. Thus, the properties of the building material (composition, viscosity, etc.) may be varied as the different components of the structure that are being printed. In certain embodiments, when printing a subterranean footing, the method may include mixing a less viscous material and the 3D printer 10 may deposit a looser flowing material (less viscous), which may be made possible by continuous on-the-spot batching from the volumetric mixer, either manually controlled or at the instruction of the control box 8, optionally in response to a measurement received by one or more sensor (e.g., FIGS. 33, 34A-34E).

The methods may include mounting an extruder subsystem capable of printing at subterranean depths to the x-axis carriage 20. The methods may include extending the extruder of the construction 3D printer to reach a subterranean depth. The methods may include smoothing the printed material in the trench to create a level footing 180 that serves as a foundation for the rest of the print. A puck 34 may be attached to the end of the extruder subsystem to smooth the deposited building material in the trench.

In certain embodiments, the methods may include dropping rebar into the footing horizontally, optionally via rebar subsystem 100 while printing to serve as reinforcement. Thus, in certain embodiments, the method may include attaching rebar subsystem 100 to the x-axis carriage 20 to drop rebar while printing the subterranean footing. In certain embodiments, both the rebar subsystem 100 and an extruder subsystem may be fitted to the x-axis carriage 20 simultaneously.

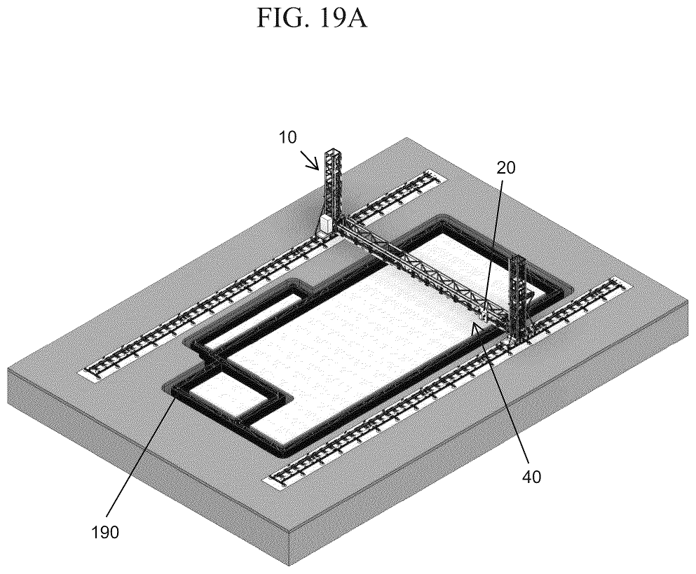

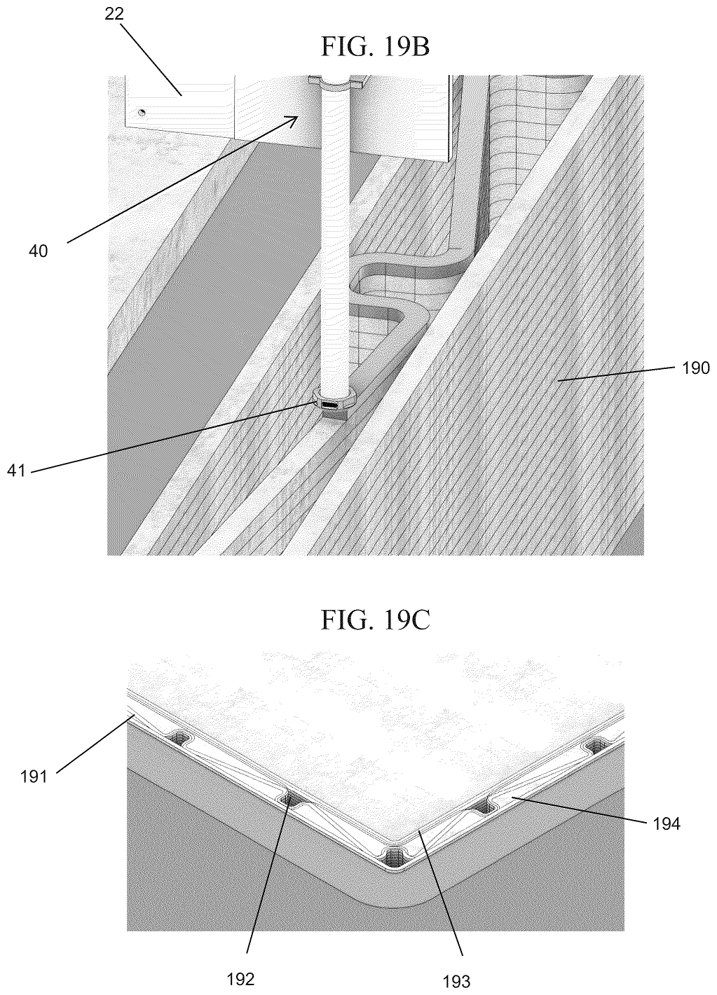

The methods may include inserting short, vertically oriented sticks of rebar at least part way into the footing. The vertical rebar may be inserted along the center of the footing. Vertical rebar may be inserted after printing and smoothing the footing. The insertion of vertical rebar may allow a complete bond of the footing to the layers above, due to the rebar being partially submerged in the footing, and later incorporated into the subsequent layers of concrete printed on top that will form the foundation walls 190 (FIG. 19A). In certain embodiments, gluing apparatus 70 may be used to ensure the layers are bonded together. Thus, the methods may comprise depositing glue or adhesive on the printed layers. The gluing apparatus 70 may be used in any step of the construction process.

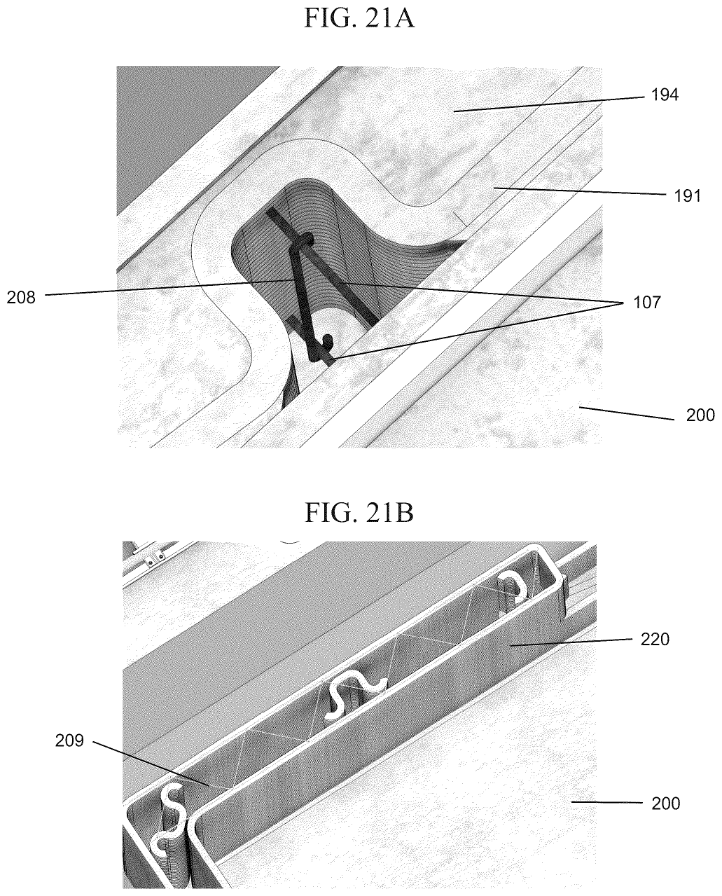

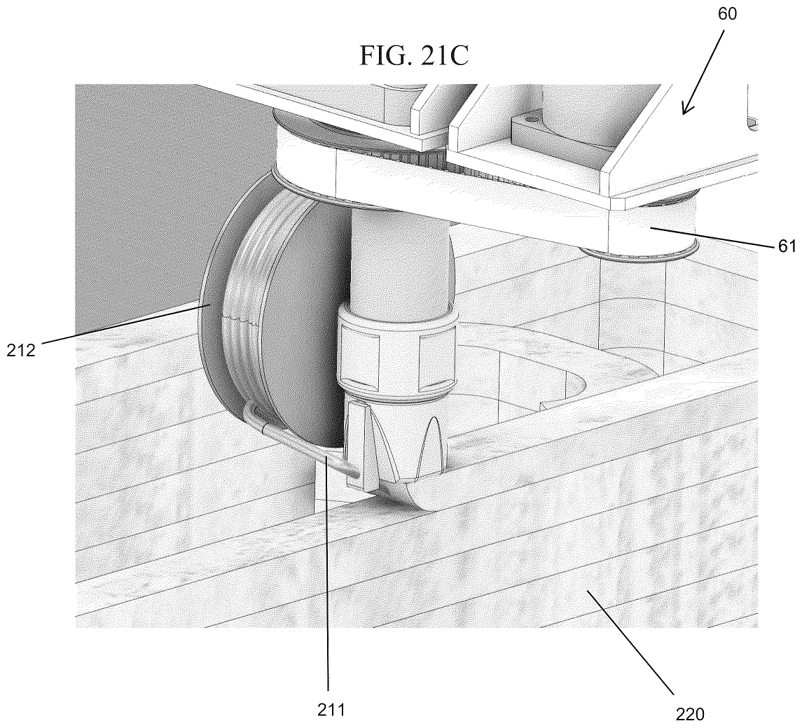

In certain embodiments, the methods may include printing a reinforcing wire or fiber 211 into the structure walls (FIG. 21C). The system may include a wire or fiber spool 212 positioned adjacent the nozzle configured to deposit wire or fiber 211 during printing.

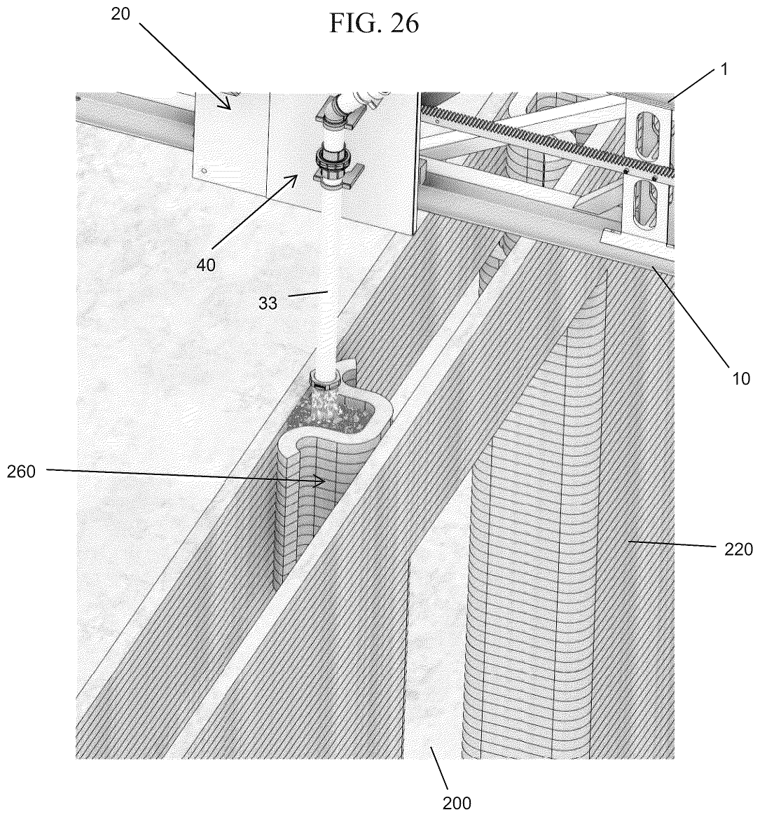

As shown in FIGS. 19B-19C, the methods may include printing an infill pattern 191, which may optionally be connected or not connected. Infill may be printed with the patterns as shown in FIGS. 23A-23B, including optionally adjacent a concave internal radius, opposite a concave external radius, adjacent a convex internal radius, or with a 90 bead cross 221. In some embodiments, a rebar hook 208 or rebar lattice mesh 209 may be placed in the wall voids before infilling (FIGS. 21A-21B). The methods may include leaving voids 192 in the foundation wall 190 backfill 194 for structural support columns. Structural support columns 260 may be formed by printing structural building material into the voids 192 (FIG. 26). The methods may include forming a keyed layer 193 adjacent the foundation walls 190 to prevent water infiltration.

Full length horizontal and vertical sticks of rebar may also or alternatively be dropped into the printed footing material (and later into structural support columns) via attachments on the gantry.

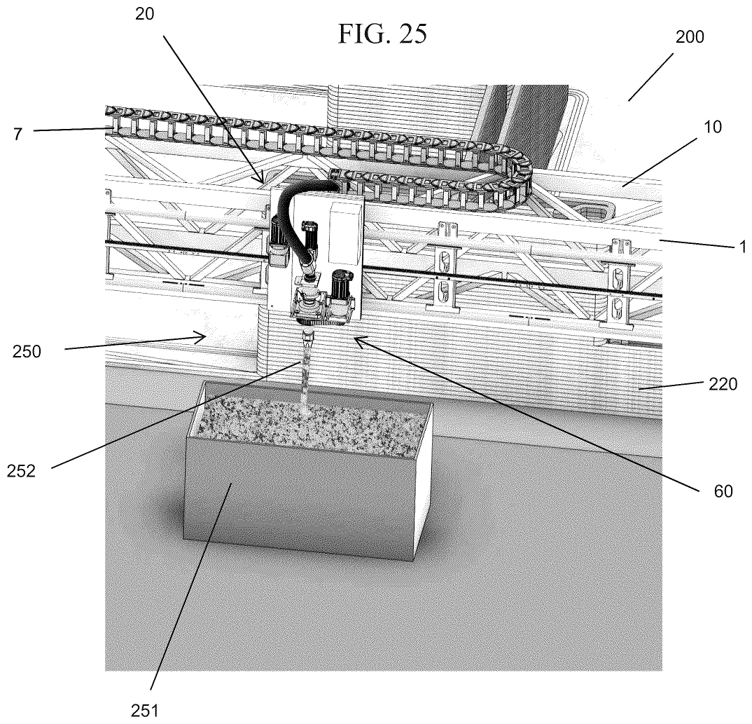

In order to keep the concrete hoses and material pipes clear of any build up, the methods may include performing periodic cleanouts (FIG. 25). In some embodiments, the cleanouts may be scheduled. For instance, cleanouts may be scheduled approximately every 3-12 hours, for example, every 3-6 hours, every 6-9 hours, or every 9-12 hours. The time between periodic cleanouts may be stretched, when necessary, to align with project goals (e.g., to occur between certain steps of the construction method, or when a personnel shift change happens, as required by Occupational Safety and Health Administration (OSHA)). In other embodiments, cleanouts may be performed, as needed. For instance, cleanouts may be performed when a certain amount of buildup is detected. Whether the cleanouts are scheduled or performed as needed, the cleanouts may be manually or automatically initiated.

Each cleanout may take approximately 1-2 hours, e.g., approximately 1 hour. An exemplary cleanout process 250 may be performed by forcing one or more balls or pucks having a diameter slightly larger than the material hose through the material hose one or more times until the hose is clear. The balls or pucks may be driven through the material hose with water from the pump or air from a compressor. In other embodiments, cleanouts may be performed with the use of a cleaning solution. The cleanout slurry 252 may be emptied into a cleanout form 251. The footing is typically formed by a large volume of concrete, and as a result it does not set up as quickly as a single 3D printed layer. However, the footings may set up sufficiently during the cleanout period, and become strong enough to support the subsequent foundation wall layers. Thus, in certain embodiments, a cleanout may follow printing of the footing. Sufficient setting up does not necessarily require full curing of the footing material. For instance, in 3D printing, it is considered a monolithic process if the material is not allowed to fully cure between construction of different components. The methods described herein may be used to create a monolithic structure.

After printing and setting of the footing, and performing the optional cleanout, the methods may comprise printing walls. At this point, the methods may comprise fitting a tangentially rotating extruder subsystem 60 to the x-axis carriage 20, optionally with a non-circular nozzle 57, to print non-circular beads of building material for the walls. If circular beads are desired, the extrusion subsystem 40 may remain in place, without any puck for smoothing, and instead using a nozzle tip 41. The material pipe 33 may be extended with all nozzle configurations, if required, to reach lower depths. In the exemplary embodiment, concrete flows through the pipe 33 into the nozzle via inlet 32. The nozzle rotates by motor 63 turning rotary gear assembly 61, which drives rotary joint 64, which subsequently spins non-circular nozzle 57.

In some embodiments, the methods may include printing subterranean foundation walls 190 with the use of a nozzle extender (FIG. 19A). The foundation wall 190 may be printed one layer at a time with no need for forms. Insulation that will go on the sides of the foundation wall 190 may be cut and prepared for installation. Insulation panels may then be placed and the bottom half of the trench may be filled with dirt. In some embodiments, the methods may include distributing insulation with insulation subsystem 90. Thus, in certain embodiments, the insulation subsystem 90 may be fitted to the x-axis carriage 20 for deposition of the insulation.

An optional waterproofing admixture may be added to the building material for printing of the foundation walls. Thus, a source of a waterproofing admixture may be directed to the volumetric mixer during preparation of the building material that will be printed as the foundation walls. In certain embodiments, a waterproofing material may be sprayed onto the foundation walls during or after printing of the walls. The waterproofing material may be sprayed by sprayers positioned on the gantry, similar to misting sprayers or paint heads. Thus, in certain embodiments, the methods may comprise fitting sprayers onto the gantry. The methods may comprise fluidly connecting a source of a waterproofing material to the sprayers.

A cleanout may be performed during printing of the foundation wall and/or during installation or deposition of the insulation. In some embodiments, the first part of the foundation wall may be printed before a cleanout is needed. The cleanout may then be performed. During the cleanout, the insulation may be prepared, either by cutting and preparing insulation panels or by preparing the insulation subsystem 90. After the cleanout, the rest of the foundation wall may be printed. Additionally or alternatively, insulation may be installed during the next cleanout.

The wall may be extended above ground level, creating a perimeter for the slab to then be backfilled. The foundation walls may be backfilled with building material, e.g., concrete, and the gaps from excavation around the perimeter of the walls may be backfilled with dirt and tamped down. In some embodiments, the backfilling building material may be deposited by the nozzle, such as a nozzle fitted to an extruder subsystem capable of printing at subterranean depths and/or a tangentially rotating extruder subsystem. The backfilling building material may be mixed by the volumetric mixer or a source of a backfilling building material may be fluidly connected to the extruder subsystem.

In certain embodiments, for example, in order to speed up the backfilling process, a hose fluidly connecting the volumetric mixer directly to the backfilling site may be used to direct a faster flow of backfilling building material, optionally with the assistance of gravity. In other embodiments, a larger pumping source may be used to increase flow rate of the building material from the volumetric mixer to the 3D printer and through the extruder subsystem.

Insulation may also be placed along the top and sides of the foundation. Expansion joints may optionally be installed in the subterranean walls and/or above ground printed walls. The expansion joints may be manually placed or printed with a subsystem similar to the insulation subsystem 90.

The traditional concrete slab construction process includes the preparation of formwork, compaction of a slab bed, placement of reinforcement, pouring, compacting, finishing the concrete, removing formwork, and curing the concrete slab. These steps may incur a minimum of 7 days and up to 28 days of wait time before any work may resume. In the construction 3D printing methods disclosed herein, no forms are required, and pucks and scrapers may be attached to the material pipe to level the material. Thus, formless construction may be performed.

The methods may comprise printing slab 200 above the foundation layer. The volumetric mixer may be set to produce a slab building material. An extruder subsystem comprising a slab printing puck 51, with or without vibrators 35, may be fitted to the extruder to level the building material.

With the systems disclosed herein, there is no need for a manual human driven screed. Printing of the walls on top of the slab may resume very quickly upon completion, as the conventional waiting steps and form removal steps may be eliminated. With the methods disclosed herein, minimal wait time is possible and may be preferable under certain circumstances.

In some embodiments, the methods may comprise marking the printed slab for placement of stub-ups and other features. The system may run a mock wall layer 156 above the printed slab as specified by G-code with paint to create a blueprint for placement of conduits using mark-out subsystem 150 (FIGS. 15B-15C). The mock wall layer 156 may be used to place the stub-ups exactly in marked locations, eliminating manual measurements. Outlet locations, wet walls, plumbing, and more may be marked on the slab by the mock wall layer with extreme accuracy. Traditional construction typically requires hand-measured spray painted lines and guesswork by electricians and other specialists, which could result in entire walls needing to be shifted to accommodate mistakes.

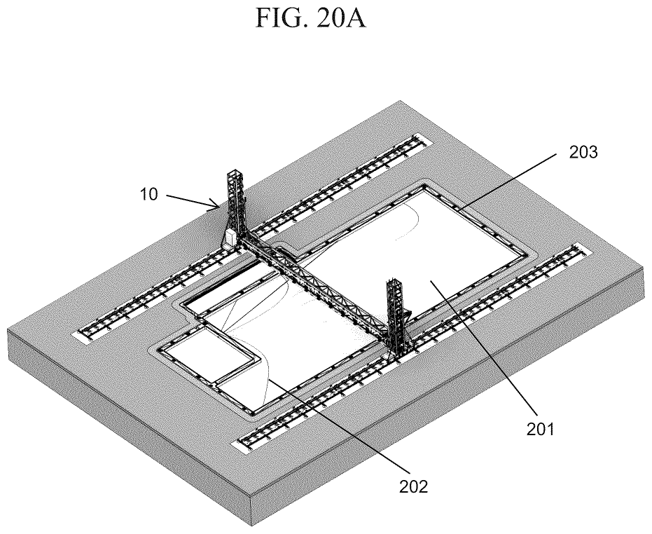

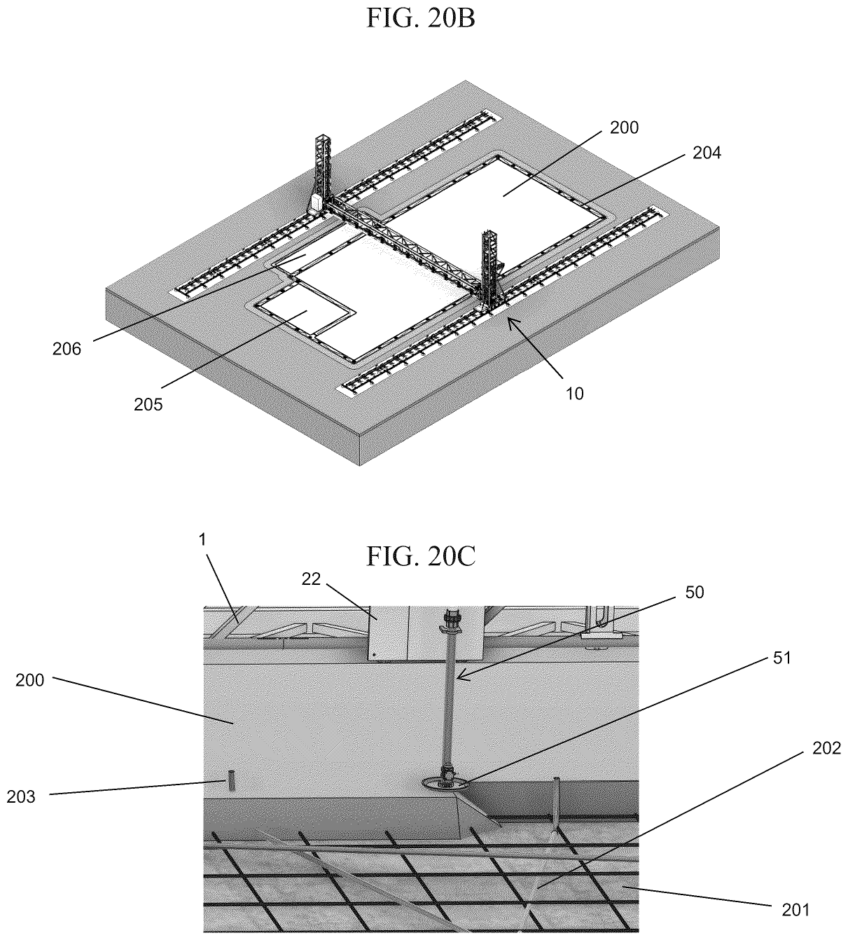

In some embodiments, the methods may comprise laying a vapor barrier 201 (FIG. 20A). While vapor barrier 201 is being laid, the conduit 202 with stub-ups 203 may be strategically placed within the planned voids of future interior and exterior walls as marked out by the mock layer 156. Slabs for the garage, utility room 205, any porches, decks, or other auxiliary features 206 may also be printed (FIGS. 20B-20C). The foundation wall may serve as a barrier 204 for backfill. Haunches may be used for disbursement of load in the case of interior load bearing walls. Thus, in certain embodiments, slab may be printed over haunches.

The methods may comprise incorporating expansion joints around the perimeter and optionally within the slab to allow for natural settling and movement. The methods may include printing a liquid, 3D printable expansion joint. Thus, in certain embodiments, the methods may include fluidly connecting a source of a liquid printable expansion joint to a nozzle.

The remainder of the vapor barrier and expansion joint may be printed, and conduit may be installed. In certain embodiments, conduit may be installed by the system disclosed herein. The slab 200 may be printed over the conduit and around the stub-ups. The slab print may be broken into as many sections as necessary, with cleanouts occurring as needed. Thus, in certain embodiments, one or more cleanout may be performed during slab printing. During the cleanouts, flex tubing may be prepared to be attached to the stub-ups for future attachment to the outlets.

Traditional construction requires framing, electrical implementation, drywall installation, etc. The methods described herein may be used to print structures using a non-circular bead, such as a rectangular bead, as described in U.S. Patent Application Publication No. 2019/0316344, titled “Autonomous robotic construction system and method,” (attached hereto as an Appendix) which is herein incorporated by reference in its entirety for all purposes. The methods may comprise printing interior and exterior walls above the printed slab. Horizontal rebar may be installed periodically throughout the print as structural reinforcement, for example, using the exemplary rebar dropping subsystem 100 (FIG. 10).

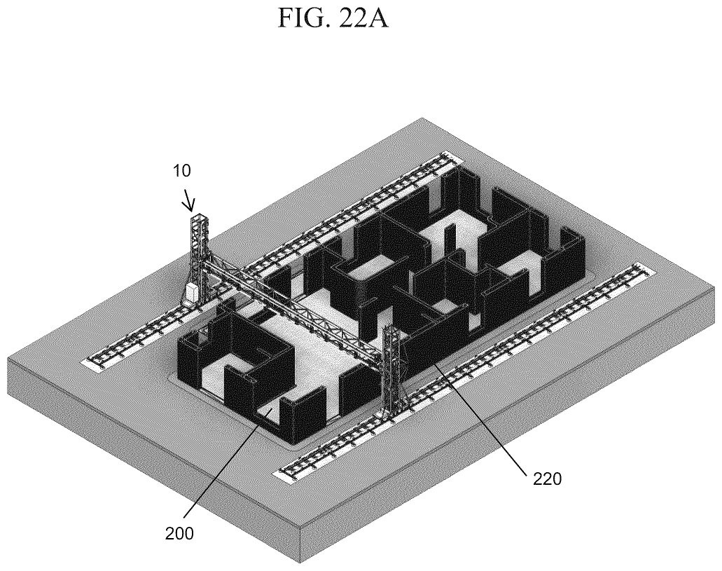

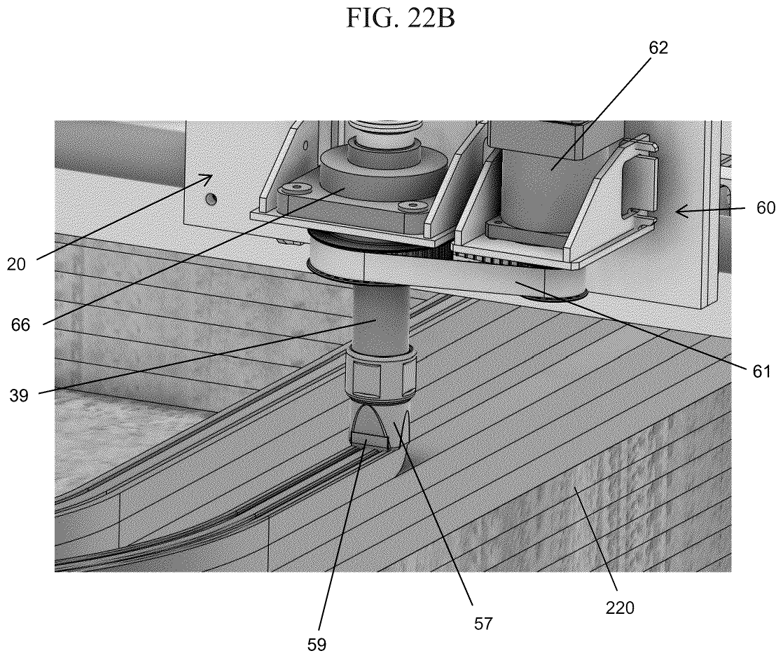

The methods may comprise printing a first section of wall 220 (FIGS. 22A-22B). After or while printing the first section, the system may locate the areas where lower electrical boxes are to be installed using code. The methods may include slicing openings for features, such as electrical boxes. In certain embodiments, the system may slice and remove printed building material at these sites via a slicing attachment 80 which may be attached or mounted on the x-axis carriage 20. The slicing blades 81 may be mechanically attached to piston or lead screw 82, which allows the concrete slicing blades 81 to reciprocate or vibrate as they cut into the freshly printed wall section. An optional cleanout may be performed during printing of the walls. While the hoses are being cleaned, the electrical boxes and flex tubing on stub-ups may be installed.

The methods may comprise printing a second section of wall. After or while printing the second section, the system may locate the areas where counter height electrical boxes are to be installed, and slice and remove the printed building material, as previously described. An optional cleanout may be performed at this stage. While the hoses are being cleaned, the electrical boxes may be installed. Flex tubing may be moved up the walls for easier access. The methods may comprise printing a third or final section of wall, taking cleanouts as scheduled or as needed. In certain embodiments, smart and/or battery operated surface mounted switches may be installed to limit the amount of conduit and cuts for boxes.

In certain embodiments, the methods may comprise dispersing an adhesive bonding agent, e.g., glue, between layers of building material. For instance, if too substantial of a time elapses between printing sessions, the adhesive may be applied. The adhesive may be used to bond the building material and avoid the formation of any cold joints or areas that may be susceptible to water infiltration. In some embodiments, the gluing apparatus 70 mounted to the x-axis carriage 20 may be used. However, the gluing apparatus 70 may be attached to the x-axis gantry 1 or the z-towers 3.

The walls may be printed to the header height. As previously described, an optional cleanout may be performed at this stage. During the cleanout following the remainder of the wall printing to the header height, rough openings, for example, for doorways and windows, may be framed out. The methods may include fitting the openings with headers to enable the continuation of printing. In some embodiments, the system may be used to fit the doorways with headers. The doors and/or windows may optionally be framed with lumber or other materials. Printing may resume on top of the openings, or lintels may be placed, depending on the engineering or architectural requirements. In some embodiments, the system may be used to place the lintels. For example, the hoist 241 (FIG. 24A) may be used to lift and place heavy steel lintels.

The method may comprise printing the interior and exterior walls 220 to a desired ceiling height (FIG. 22A). An optional cleanout may be performed at the completion of the walls.

The methods may comprise filling the wall voids formed during printing of the walls with insulation (FIG. 9B). In some embodiments, insulation may be deposited during the cleanout period. The walls may be backfilled with insulation using insulation subsystem 90 mounted on the x-axis carriage 20. The voids of the walls may be filled from the bottom at the slab up to the full height of the wall, minus the required height for the bond beam to be backfilled with concrete. This serves as a post construction system with or without rebar, depending on the chosen building material. The insulation may be firm enough to support the bond beam concrete as it is slowly added.

Additionally, in some embodiments, vertical sticks of rebar may be put into the vertical support column voids. Vertical rebar may be installed with alternate attachments on the rebar subsystem 100, as previously described. In some embodiments, the rebar may be deposited simultaneously with insulation, before insulation, or after insulation.

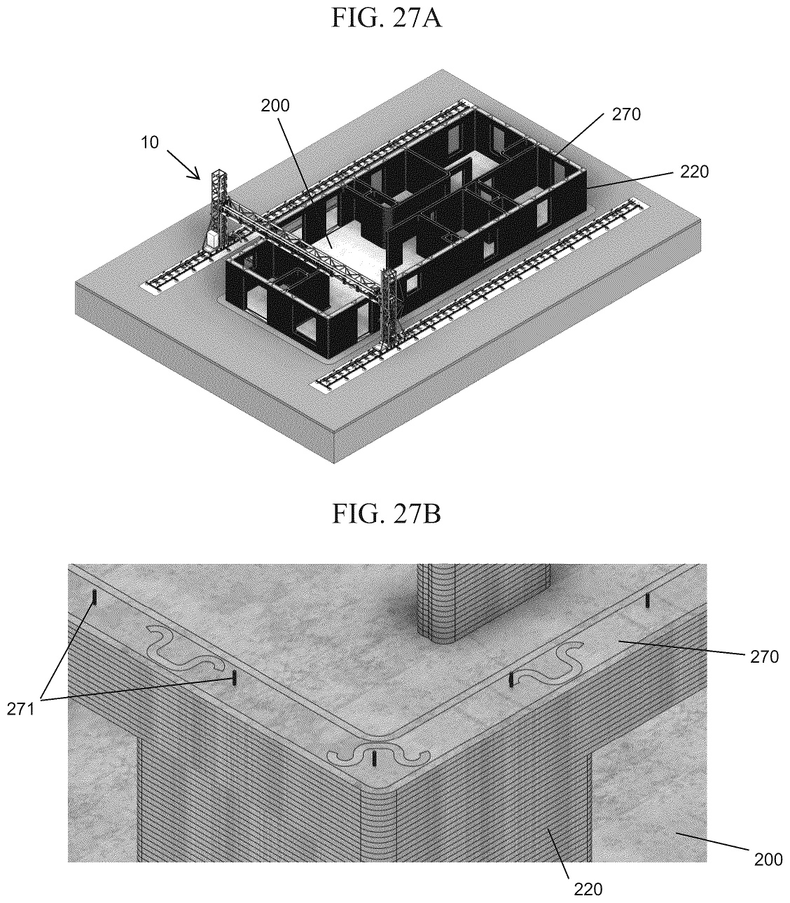

The methods may comprise backfilling the vertical support columns with backfilling building material, encasing the vertical sticks of rebar. Once the insulation is installed, the bond beam 270 may be backfilled around the perimeter of the house (FIGS. 27A-27B). In some embodiments, the bond beam may be installed with the system. J-bolts 271 may be embedded in the bond beam.

In certain embodiments, the methods may include misting the structure (FIG. 12F), for example, with a misting nozzle clips 121. The methods may include printing interior and exterior components and fixtures, for example, with plastic printer 300. The methods may include painting the structure, for example, with paint apparatus 130 (FIGS. 13A-13B). During painting, first a coat of primer paint may be applied to fully seal the exterior beads, and then any color paint may be applied over the primer. Thus, in certain embodiments, the methods may include fitting one or more of the misting clips 121, plastic printer 300, and paint apparatus 130 to the system.

The methods may comprise forming a roof over the structure. Traditional construction requires pre-built trusses or framing for the addition of a roof. In 3D printed construction, the roof is generally fireproof. Decking may be used to support 3D printed material and gutters, solar panels, water capture systems, and other features that may be integrated onto or adjacent to the roof.

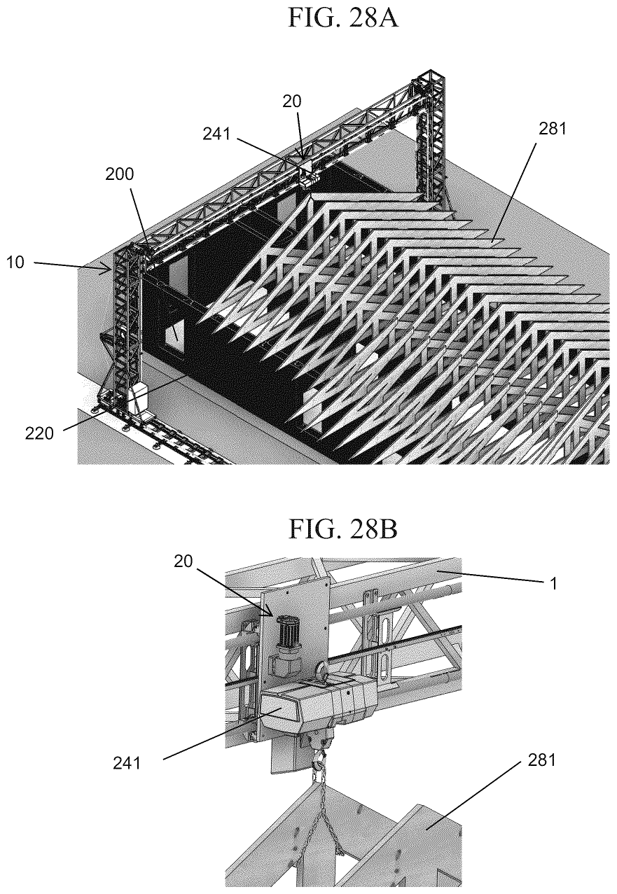

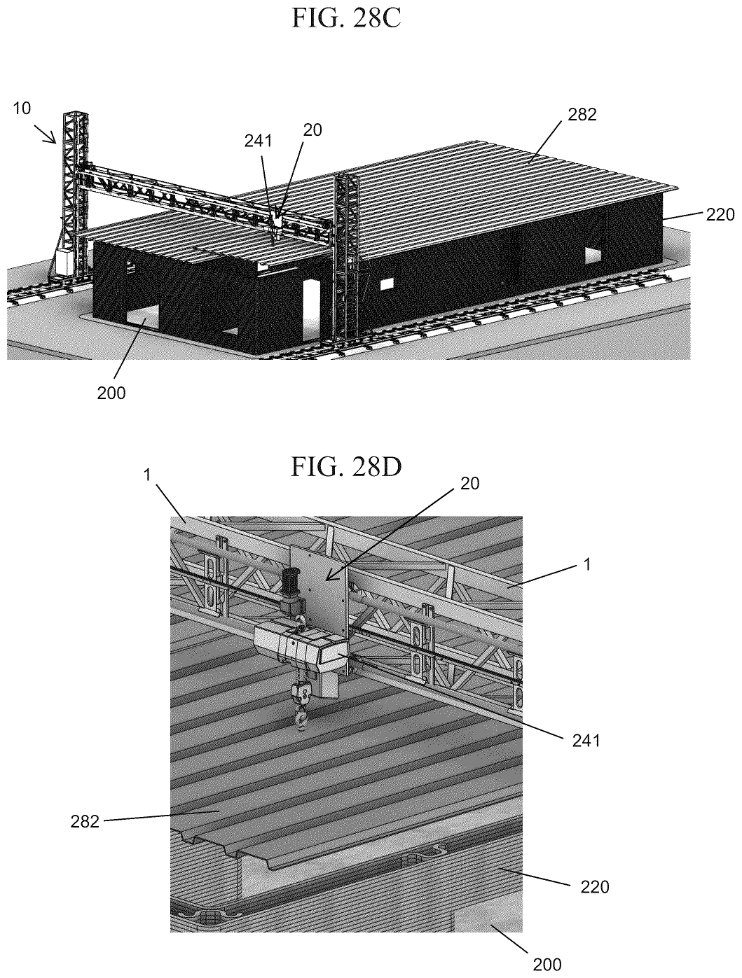

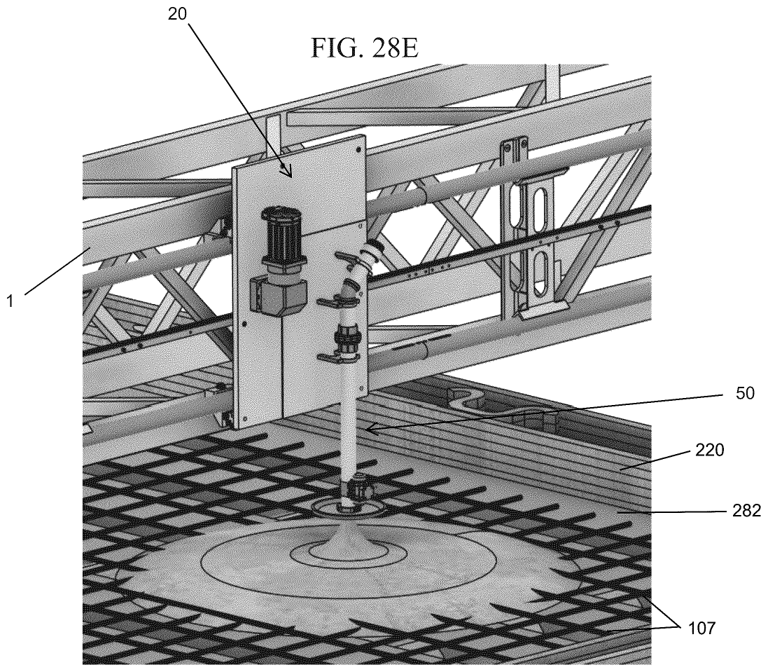

Before 3D printing the roof, decking 282 may be laid across the top of the structure and attached to j-bolts 271 and/or connection points that have been embedded in the bond beam. The methods may comprise installing a roof truss 281 (FIG. 28A). In certain embodiments, the roof truss 281 may be lifted by hoist 241 (FIG. 28B). The decking may be steel or composite decking that is fixed or removable. The methods may comprise lifting the decking up to the roof level with hoist 241 (FIG. 28C-28D). The construction 3D printer's lifting function may be used to hoist the roof panels and place them along the printed structure. A vapor barrier may be installed on top of the decking.

In certain embodiments, misting, printing interior or exterior fixtures, or painting may be performed before putting the roof onto the printed walls. The construction of the structure may still be considered continuous and monolithic due to the embedded connection points within the structure's bond beam.

Once the panels are laid, the method may comprise printing the perimeter of the roof to serve as a barrier for backfilling and then backfilling the roof with a backfilling building material (FIG. 28E). The extruder subsystem 50 comprising a slab leveling puck 51 may be used to smooth out the printed building material. In some embodiments, the roof building material may be a lightweight concrete, mixed in real time by the volumetric mixer. A waterproofing admixture may be incorporated into the building material or applied after printing of the roof, as previously described with respect to the footings. Use of the waterproofing admixture may remove the need for seals.

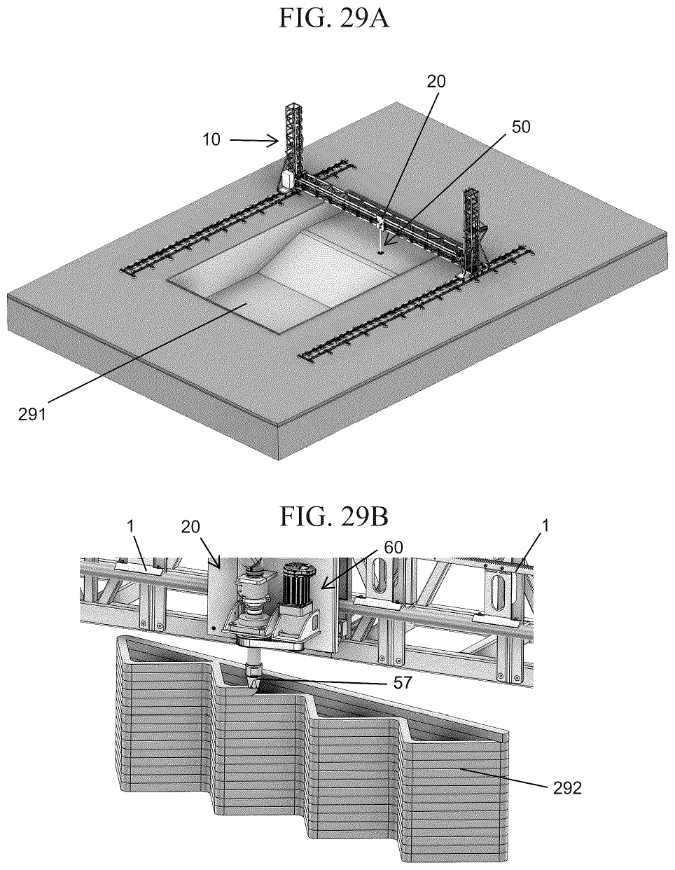

Auxiliary structures may also be printed with the systems described herein. For example, in some embodiments, the methods may comprise 3D printing a pool 291 in an excavated truss (FIG. 29A). In some embodiments, the methods may comprise 3D printing stairs 292 with an extruder subsystem (FIG. 29B). The methods may include plastic 3D printing fixtures or other components, such as trim 305 (FIG. 30B).

FIGS. 35A-35B summarize one embodiment of the method of constructing a 3D printed structure, as described herein.

This continuous construction 3D printing process described herein may also be performed for basement construction, and for construction of structures having multiple stories. Printing of interior components of the structure with a recycling plastic printer is optional, and may help to reduce cost and increase the percentage of the structure autonomously constructed. Steps of the process may be altered depending on the build requirements. In the case of no garages, porches, or other auxiliary features to be completed while other aspects are being prepared, the project may be done as a split print in order to keep the processes moving at all times.

Additionally, more subsystems or attachments may be utilized with the system to further improve the process. For example, rolling attachments 140 may be used to remove the layer lines of the walls while printing to avoid the need to add a stucco finish to the walls after the print. However, other materials such as tile, wood, sheet rock, etc. may alternatively be fixed to any of the walls after the print, but doing so generally increases the project cost, time, and lead to material waste.

Additionally, while the methods described herein may be performed without forms, in certain embodiments, cleanout forms 251 (FIG. 25) may be used for the start-up and cleanout process, to reduce concrete waste. These custom or standard cleanout forms may later be used as roadblocks, barricades, walls, pavers, and more.

Conventional systems in the construction 3D printing space do not have adequate technology to complete the entire process, much less to produce a monolithic structure. For instance, conventional nozzles are generally too short and cannot be extended to reach subterranean depths, due to the presence of pressure sleeves and auxiliary tanks and systems at the extruder level. Additionally, conventional methods have not integrated the processes to allow for a fully 3D printed structure.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

1-17. (canceled)

18. A method of building a subterranean structure with a construction 3D printing system comprising at least one frame comprising tracks and an x-axis carriage, a source of a building material, and a pump configured to pump the building material through a material hose, the method comprising:
attaching an extruder dimensioned to reach subterranean depths to the x-axis carriage, fluidly connecting the extruder to the material hose, and printing a subterranean footing in a trench;
depositing rebar at least partly into the footing;
attaching a tangentially rotating non-circular nozzle to the x-axis carriage, fluidly connecting the tangentially rotating non-circular nozzle to the material hose, and printing foundation walls over the subterranean footing;
installing insulation adjacent the foundation walls; and
printing slab above the foundation walls.

19-24. (canceled)

25. A method of building a roof on a structure with a construction 3D printing system comprising at least one frame comprising tracks and an x-axis carriage, a source of a building material, and a pump configured to pump the building material through a material hose to an extruder, the method comprising:
printing walls of the structure with a nozzle fitted to the extruder;
depositing insulation adjacent the walls;
embedding a plurality of j-hooks into bond beam installed around a perimeter of the structure;
lifting at least one decking panel onto the walls and attaching the decking panel to the j-hooks; and
printing the roof over the decking.

26-35. (canceled)

36. A construction 3D printing system comprising:
at least one frame comprising tracks and an x-axis carriage;
the x-axis carriage being operably positioned along the tracks;
a volumetric mixer fluidly connectable to a source of powder material and a source of water, wherein the volumetric mixer is configured to combine the powder material and water into a building material;
a pump configured to pump the building material though a material hose;
a plurality of modular subsystems, each modular subsystem comprising a mounting plate releasably mountable to the x-axis carriage;
the plurality of modular subsystems including a primary subsystem comprising an extruder connectable to the material hose, whereby the building material is dispensed from the primary subsystem;
the plurality of modular subsystems including at least one ancillary subsystem releasably mountable to the x-axis carriage, whereby the primary subsystem and the at least one ancillary subsystem are configured to facilitate the uninterrupted construction of a standing structure.

37. The construction 3D printing system of claim 36, the primary subsystem further comprising a material pipe;
the material hose being fluidly connected to the material pipe; and
a distal end of the material pipe being positioned offset from the x-axis carriage.

38. The construction 3D printing system of claim 37, wherein the primary subsystem further comprises a screeding puck terminally mounted to the distal end of the material pipe, opposite the material hose.

39. The construction 3D printing system of claim 38, wherein the screeding puck is flexibly mounted onto the material pipe, such that the screeding puck is laterally compliant about the material pipe.

40. The construction 3D printing system of claim 38, wherein the primary system further comprises a plurality of vibrators distributed across the screeding puck.

41. The construction 3D printing system of claim 36, wherein the at least one ancillary subsystem comprises at least one hoist extensible from the x-axis carriage.

42. The construction 3D printing system of claim 41, wherein the at least one hoist is configured to controllably position a construction component onto the building material dispensed from the primary subsystem.

43. The construction 3D printing system of claim 36, wherein the at least one ancillary subsystem comprises at least one paint sprayer;
the at least one paint sprayer being fluidly connectable to a source of paint; and
the at least one paint sprayer being configured to be used simultaneously or partially simultaneously with the primary subsystem.

44. The construction 3D printing system of claim 43, wherein the at least one ancillary subsystem further comprises a plurality of paint sprayers fluidly connectable to the source of paint; and
the plurality of paint sprayers being distributed along the tracks.

45. The construction 3D printing system of claim 43, wherein the at least one ancillary subsystem further comprises a selectable manifold;
the selectable manifold being fluidly connected between the at least one paint sprayer and the source of paint.

46. The construction 3D printing system of claim 36, comprising a plurality of lights distributed across at least one frame and the x-axis carriage.

47. The construction 3D printing system of claim 46, comprising at least one camera mounted onto the x-axis carriage, positioned to monitor construction of the standing structure between the plurality of modular subsystems.

48. The construction 3D printing system of claim 36, wherein the at least one ancillary subsystem comprises a plastic extruder and a plastic shredder;
the plastic extruder being terminally connected to the plastic shredder; and
the plastic extruder head being configured to controllably dispense plastic material adjacent to the building material dispensed from the primary subsystem.

49. The construction 3D printing system of claim 36, wherein the at least one ancillary subsystem comprises a glue sprayer fluidly connected to an adhesive tank; and
the glue sprayer being mounted coaxial to the primary subsystem, capable of applying a volume of adhesive to a volume of building material.

50. The construction 3D printing system of claim 36, wherein the primary subsystem further comprises a tangentially rotating element and an extrusion nozzle;
the tangentially rotating element being mounted to the material hose, wherein the building material is configured to flow through the tangentially rotating element;
the extrusion nozzle being releaseably mounted to the tangentially rotating element, opposite the material hose; and
the tangentially rotating element enabling rotation of the extrusion nozzle for directional printing.

51. The construction 3D printing system of claim 50, wherein the extrusion nozzle comprises a non-circular aperture configured to print the building material formed into a non-circular geometry.

52. The construction 3D printing system of claim 36, wherein the at least one ancillary subsystem comprises an insulation dispenser and a source of insulation material;
the insulation dispenser being fluidly connectable to the source of insulation material; and
the insulation dispenser being positioned to dispense a volume of insulation material adjacent a wall formed by building material dispensed from the primary subsystem.

53. The construction 3D printing system of claim 36, wherein the at least one ancillary subsystem comprises an excavation system; and
the excavation system being operable within a range of the x-axis carriage, whereby the excavation system is configured to extract and convey soil.

54. The construction 3D printing system of claim 53, wherein the at least one ancillary subsystem further comprises a bucket and hydraulic cylinders mounted to the mounting plate;
the bucket being terminally mounted, offset from the x-axis carriage; and
wherein the bucket is configured to convey extracted soil.

55. The construction 3D printing system of claim 36, wherein the at least one ancillary subsystem comprises at least one pressure dispenser, a source of water, and an extraction hose;
the extraction hose being connected to the mounting plate;
the source of water being fluidly connected to the at least one pressure dispenser;
the at least one pressure dispenser being positioned adjacent to the extraction hose; and
the at least one pressure dispenser being configured to dislodge soil with pressurized water and the extraction hose being configured to relocate the dislodged soil.

56. The construction 3D printing system of claim 36, wherein the at least one ancillary subsystem comprises a mark-out apparatus; and
the mark-out apparatus being mounted at a fixed offset from the primary subsystem, and configured to shadow the position of the primary subsystem to print a mock wall layer.

57. The construction 3D printing system of claim 56, wherein the at least one ancillary subsystem further comprises a spray paint can and an activation lever;
the spray paint can being releasably mounted to the mounting plate of the at least one ancillary subsystem, such that the output of the spray paint can is directed opposite the x-axis carriage; and
the lever being controllably positioned against the spray paint can, such that the motion of the lever projects a volume of paint to be dispensed onto a target surface.

58. The construction 3D printing system of claim 36, wherein the at least one ancillary subsystem comprises a roller apparatus.

59. The construction 3D printing system of claim 36, wherein the at least one ancillary subsystem further comprises a plurality of misting nozzles and a source of water;
the plurality of misting nozzles being distributed about the primary subsystem, directed towards an output of the primary subsystem; and
the source of water being fluidly connected to the plurality of misting nozzles.

60. The construction 3D printing system of claim 59, wherein the at least one ancillary subsystem further comprises a control solenoid;
the control solenoid being fluidly connected between the plurality of misting nozzles and the source of water; and
the control solenoid moderating a flow of water to the plurality of misting nozzles.

61. The construction 3D printing system of claim 36, wherein the at least one ancillary subsystem comprises a rebar placement apparatus, wherein the rebar placement apparatus is configured to dispense rebar into the building material dispensed from the primary subsystem.

62. The construction 3D printing system of claim 61, wherein the at least one ancillary subsystem further comprises a tangential deployment mechanism and a rebar hopper;
the tangential deployment mechanism being positioned between the rebar hopper and the primary subsystem, wherein the tangential deployment mechanism is configured to extract a unit of rebar material from the rebar hopper; and
the tangential deployment mechanism being configured to operably rotate relative to the rebar hopper, to direct the unit of rebar material extracted from the rebar hopper in a selected direction relative to the building material dispensed from the primary subsystem.

63. The construction 3D printing system of claim 61, wherein the at least one ancillary subsystem further comprises a rebar hopper, a rebar orienter plate, and a release mechanism;
a unit of rebar material being distributed from the rebar hopper through the rebar orienter plate; and
the release mechanism being configured to extract the unit of rebar material through the rebar orienter plate.

64. The construction 3D printing system of claim 36, wherein the at least one ancillary subsystem comprises at least one roller and a tangential rotation mechanism;
the tangential rotation mechanism being connected between the mounting plate and at least one roller; and
the at least one roller being operably positioned to engage the at least one roller adjacent the building material to modify a shape of the building material.

65. The construction 3D printing system of claim 36, wherein the at least one ancillary subsystem comprises a first slicing blade and a second slicing blade;
the second slicing blade being positioned offset from the first slicing blade.

66. The construction 3D printing system of claim 36, wherein the at least one ancillary subsystem comprises at least one material sensor and a control box;
the at least one material sensor being positioned to measure a parameter of the building material;
the control box programmed to control building material composition in the volumetric mixer responsive to the measured parameter.

67. The construction 3D printing system of claim 66, wherein the control box is communicably coupled with a pump of the volumetric mixer;
the control box being programmed to modify a ratio of powder material and water combined in the volumetric mixer to produce the building material.
